(19) United States
(12) Patent Application Publication
(10) Pub. No.: US 2021/0182584 A1
(43) Pub. Date: Jun. 17, 2021

(54) METHODS AND SYSTEMS FOR DISPLAYING A VISUAL AID AND ENHANCING USER LIVENESS DETECTION

(71) Applicant: DAON HOLDINGS LIMITED, George Town (KY)

(72) Inventor: Mircea IONITA, Dublin (IE)

(21) Appl. No.: 17/173,421

(22) Filed: Feb. 11, 2021

Related U.S. Application Data
(63) Continuation-in-part of application No. 16/716,958, filed on Dec. 17, 2019.

(51) Int. Cl. G06K 9/00; G06T 7/70; G06K 9/62; G06N 20/00

(52) U.S. Cl. CPC G06K 9/00906; G06T 7/70; G06K 9/00255; G06T 2207/30201; G06K 9/6255; G06N 20/00; G06K 9/6215

(57) ABSTRACT

A method for displaying a visual aid is provided that includes calculating a distortion score based on an initial position of a computing device and comparing, by the computing device, the distortion score against a threshold distortion value. When the distortion score is less than or equal to the threshold distortion value, a visual aid is displayed having a first size and when the distortion score exceeds the threshold distortion value the visual aid is displayed at a second size.

### CROSS-REFERENCE TO RELATED APPLICATIONS

This is a continuation-in-part application of U.S. patent application Ser. No. 16/716,958, filed Dec. 17, 2019, the disclosure of which is incorporated herein by reference.

### BACKGROUND OF THE INVENTION

This invention relates generally to capturing user image data, and more particularly, to methods and systems for displaying a visual aid while capturing user image data and enhancing user liveness detection.

Users conduct transactions with many different service providers in person and remotely over the Internet. Network-based transactions conducted over the Internet may involve purchasing items from a merchant web site or accessing confidential information from a web site. Service providers that own and operate such websites typically require successfully identifying users before allowing a desired transaction to be conducted.

Users are increasingly using smart devices to conduct such network-based transactions and to conduct network-based biometric authentication transactions. Some network-based biometric authentication transactions have more complex biometric data capture requirements which have been known to be more difficult for users to comply with. For example, some users have been known to position the smart device near their waist when capturing a facial image. Many users still look downwards even if the device is held somewhere above waist level. Such users typically do not appreciate that differently positioning the smart device should result in capturing better image data. Consequently, capturing image data of a biometric modality of such users that can be used for generating trustworthy authentication transaction results has been known to be difficult, annoying, and time consuming for users and authentication service providers. Additionally, capturing such image data has been known to increase costs for authentication service providers.

For service providers who require biometric authentication, people provide a claim of identity and remotely captured data regarding a biometric modality. However, imposters have been known to impersonate people by providing a false claim of identity supported by fraudulent data in an effort to deceive an entity into concluding the imposter is the person he or she claims to be. Such impersonations are known as spoofing.

Impostors have been known to use many methods to obtain or create fraudulent data for a biometric modality of another person that can be submitted during biometric authentication transactions. For example, imposters have been known to obtain two-dimensional pictures from social networking sites which can be presented to a camera during authentication to support a false claim of identity. Imposters have also been known to make physical models of a biometric modality, such as a fingerprint using gelatin or a three-dimensional face using a custom mannequin. Moreover, imposters have been known to eavesdrop on networks during legitimate network-based biometric authentication transactions to surreptitiously obtain genuine data of a biometric modality of a person. The imposters use the obtained data for playback during fraudulent network-based authentication transactions. Such fraudulent data are difficult to detect using known liveness detection methods. Consequently, generating accurate network-based biometric authentication transaction results with data for a biometric modality captured from a person at a remote location depends on verifying the physical presence of the person during the authentication transaction as well as accurately verifying the identity of the person with the captured data. Verifying that the data for a biometric modality of a person captured during a network-based biometric authentication transaction conducted at a remote location is of a live person is known as liveness detection or anti-spoofing.

Liveness detection methods have been known to use structure derived from motion of a biometric modality, such as a person's face, to distinguish a live person from a photograph. Other methods have been known to analyze sequential images of eyes to detect eye blinks and thus determine if an image of a face is from a live person. Yet other methods have been known to illuminate a biometric modality with a pattern to distinguish a live person from a photograph.

Additionally, liveness detection methods are also known that assess liveness based on three-dimensional (3D) characteristics of the face in a multimodal approach in which specialized camera hardware is used that captures the full 3D environment. Such camera hardware typically includes a stereo vision camera system which is able to generate a depth map representation. The stereo vision camera system is usually paired with standard red-green-blue (RGB) image and/or infrared (IR) cameras.

RGB cameras are the most commonly available and used cameras, which cover rich details in a facial image. Depth information is considered to be an important modality that can play a key role in discriminating between live and spoof faces. The natural features of a live face have a well-defined 3D relief, e.g., in a frontal view the nose is closer to camera than the eyes, compared to a face printed or displayed on a screen which instead present flat surface characteristics. IR cameras are used to measure the amount of heat radiated from a face which is used to complement depth information, and help remove false positive spoof attack detections from the depth sensing camera(s).

However, the above-described methods may not be considered to be convenient and may not accurately detect spoofing. Moreover, specialized equipment can be expensive, difficult to operate, and hard to obtain and typically cannot be implement using devices, such as smartphones, tablet computers, and laptop computers that are readily available to and easily operated by most people. As a result, these methods may not provide high confidence liveness detection support for service providers dependent upon accurate biometric authentication transaction results.

### BRIEF DESCRIPTION OF THE INVENTION

In one aspect, a method for displaying a visual aid that includes calculating a distortion score based on an initial position of a computing device, and comparing, by the computing device, the distortion score against a threshold distortion value. When the distortion score is less than or equal to the threshold distortion value, a visual aid having a first size is displayed and when the distortion score exceeds the threshold distortion value the visual aid is displayed at a second size.

In another aspect, a computing device for displaying a visual aid is provided that includes a processor and a memory configured to store data. The computing device is associated with a network and the memory is in communication with the processor and has instructions stored thereon which, when read and executed by the processor, cause the computing device to calculate a distortion score based on an initial position of the computing device and compare the distortion score against a threshold distortion value. When the distortion score is less than or equal to the threshold distortion value a visual aid having a first size is displayed and when the distortion score exceeds the threshold distortion value the visual aid is displayed at a second size.

In yet another aspect, a method for displaying a visual aid is provided that includes establishing limits for a change in image data distortion. The method also includes calculating a distance ratio for each limit, calculating a width of a visual aid based on the maximum distance ratio, and displaying the visual aid.

An aspect of the present disclosure provides an electronic device for enhanced liveness detection that includes a camera, a processor, and a memory configured to store data. The electronic device is associated with a network and the memory is in communication with the processor and has instructions stored thereon which, when read and executed by the processor, cause the electronic device to capture facial image data of a user while there is relative movement between the electronic device and the user and select pairs of frames from the captured facial image data. Each frame has a distortion score and a difference between the distortion scores for each pair at least equals a threshold difference. Moreover, the instructions when read and executed by the processor cause the electronic device to create a spatial displacement map for each pair of frames, calculate a confidence score for each pair of frames based on the displacement map created for each respective pair of frames, and determine whether the captured facial image data was taken of a live person based on the confidence scores.

In an embodiment of the present disclosure, the instructions when executed by the processor further cause the electronic device to calculate the position of each pixel in the facial image data in each frame of each pair and calculate the difference in position of each pixel between the frames of each respective pair.

In an embodiment of the present disclosure, the instructions when executed by the processor further cause the electronic device to calculate the position of each pixel within different blocks of pixels in the facial image data in each frame of each pair, calculate the difference in position of each block of pixels between the frames of each respective pair, and average the calculated differences in position to estimate the movement between the facial image data in the frames of each respective frame pair.

In an embodiment of the present disclosure, the instructions when executed by the processor further cause the electronic device to input the spatial displacement map created for a pair of the selected frames into a machine learning algorithm (MLA) and calculate a confidence score for the pair of frames using the MLA.

In an embodiment of the present disclosure, the instructions when executed by the processor further cause the electronic device to calculate an overall confidence score from the confidence scores, compare the overall confidence score against a threshold confidence score, and determine the facial image data was taken of a live person when the overall confidence score at least equals the threshold score.

In an embodiment of the present disclosure, the instructions when executed by the processor further cause the electronic device to calculate a liveness detection score for the image data in each frame using at least one of a first machine learning algorithm (MLA) trained model and a second MLA trained model.

An aspect of the present disclosure provides a method for enhancing user liveness detection that includes capturing, by a camera in an electronic device, facial image data of a user while there is relative movement between the electronic device and the user. Additionally, the method includes selecting pairs of frames from the captured facial image data, wherein each frame has a distortion score and a difference between the distortion scores for each pair at least equals a threshold difference. Moreover, the method includes creating, by the electronic device, a spatial displacement map for each pair of frames, calculating a confidence score for each pair of frames based on the displacement map created for each respective pair of frames, and determining whether the captured facial image data was taken of a live person based on the confidence scores.

In an embodiment of the present disclosure, the spatial displacement map is created by calculating the position of each pixel in the facial image data in each frame of each pair, and calculating the difference in position of each pixel between the frames of each respective pair.

In an embodiment of the present disclosure, the special displacement map is created by calculating the position of each pixel within different blocks of pixels in the facial image data in each frame of each pair, calculating the difference in position of each block of pixels between the frames of each respective pair, and averaging the calculated differences in position to estimate the movement between the facial image data in the frames of each respective frame pair.

In an embodiment of the present disclosure, the confidence score is calculated by inputting the spatial displacement map created for a pair of the selected frames into a machine learning algorithm (MLA) and calculating a confidence score for the pair of frames using the MLA.

In an embodiment of the present disclosure, the determining step includes calculating an overall confidence score from the confidence scores, comparing the overall confidence score against a threshold confidence score, and determining the facial image data was taken of a live person when the overall confidence score at least equals the threshold score.

In an embodiment of the present disclosure, the method further includes the step of calculating a liveness detection score for the image data in each frame using at least one of a first machine learning algorithm (MLA) trained model and a second MLA trained model.

An aspect of the present disclosure provides a non-transitory computer-readable recording medium in an electronic device for enhanced liveness detection. The non-transitory computer-readable recording medium stores one or more programs which when executed by a hardware processor performs the steps of the methods described above.

### BRIEF DESCRIPTION OF THE DRAWINGS

FIG. 1 is a diagram of an example computing device used for displaying a visual aid and detecting user liveness according to an embodiment of the present disclosure;

FIG. 2 is a side view of a person operating the computing device in which the computing device is in an example initial position;

FIG. 3 is an enlarged front view of the computing device displaying a facial image of the user when the computing device is in the initial position;

FIG. 4 is an enlarged front view of the computing device as shown in FIG. 3, further displaying a first example visual aid;

FIG. 5 is a side view of the user operating the computing device in which the computing device is in a first example terminal position;

FIG. 6 is an enlarged front view of the computing device in the first terminal position displaying the facial image approximately aligned with the first visual aid;

FIG. 7 is an enlarged front view of the computing device as shown in FIG. 6; however, the facial image and visual aid are larger;

FIG. 8 is an enlarged front view of the computing device displaying the first visual aid as shown in FIG. 7;

FIG. 9 is a side view of the user operating the computing device in which the computing device is in a second example initial position;

FIG. 10 is an enlarged front view of the computing device displaying the facial image of the user when the computing device is in the second example initial position;

FIG. 11 is an enlarged front view of the computing device displaying the facial image and a second example visual aid;

FIG. 12 is a side view of the user operating the computing device in a second example terminal position;

FIG. 13 is an enlarged front view of the computing device in the second example terminal position displaying the facial image approximately aligned with the second visual aid;

FIG. 14 is an example curve illustrating the rate of change in the distortion of biometric characteristics included in captured facial image data;

FIG. 15 is the example curve as shown in FIG. 14 further including an example change in distortion;

FIG. 16 is the example curve as shown in FIG. 15; however, the initial position of the computing device is different;

FIG. 17 is the example curve as shown in FIG. 15; however, the terminal position is not coincident with the position of a threshold distortion value;

FIG. 18 is the example curve as shown in FIG. 17; however, the change in distortion occurs between different limits;

FIG. 19 is the example curve as shown in FIG. 18; however, the change in distortion occurs between different limits;

FIG. 20 is the example curve as shown in FIG. 19; however, the change in distortion occurs between different limits;

FIG. 21 is a flowchart illustrating an example method of displaying a visual aid;

FIG. 22 is a flowchart illustrating another example method of displaying a visual aid;

FIG. 23 is a flowchart illustrating an example method and algorithm for enhancing user liveness detection results according to an embodiment of the present disclosure;

FIG. 24 is a flowchart illustrating another example method and algorithm for enhancing user liveness detection results according to another embodiment of the present disclosure;

FIG. 25 is a flowchart illustrating yet another example method and algorithm for enhancing user liveness detection results according to yet another embodiment of the present disclosure;

FIG. 26 is a flowchart illustrating yet another example method and algorithm for enhancing user liveness detection results according to yet another embodiment of the present disclosure; and

FIG. 27 is a flowchart illustrating yet another example method and algorithm for enhancing user liveness detection results according to yet another embodiment of the present disclosure.

### DETAILED DESCRIPTION OF THE INVENTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

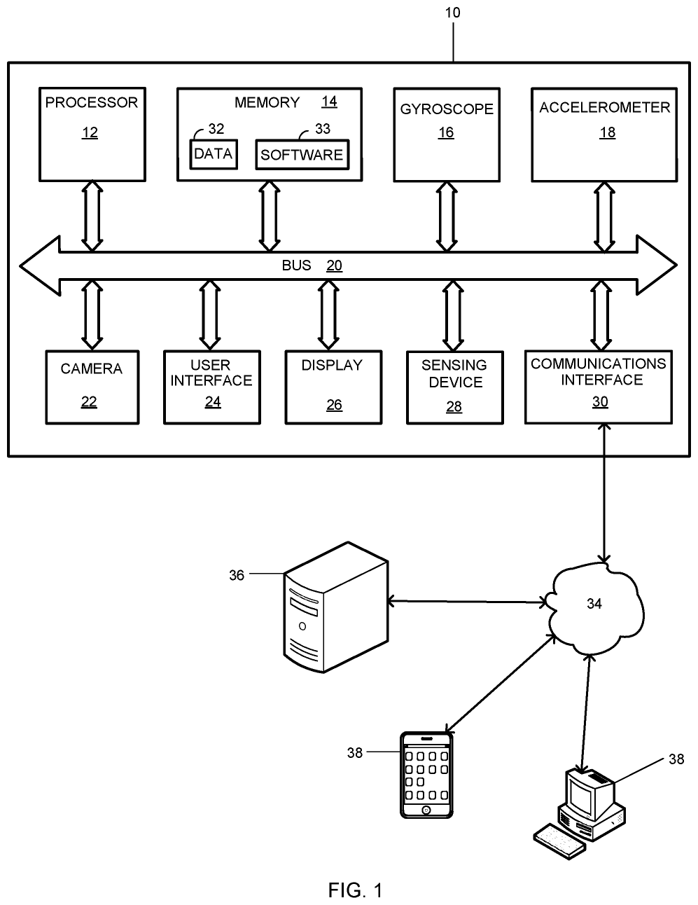

FIG. 1 is a schematic diagram of an example computing device 10 used for displaying a visual aid and enhancing user liveness detection according to an embodiment of the present disclosure. The computing device 10 includes components such as, but not limited to, one or more processors 12, a memory 14, a gyroscope 16, one or more accelerometers 18, a bus 20, a camera 22, a user interface 24, a display 26, a sensing device 28, and a communications interface 30. General communication between the components in the computing device 10 is provided via the bus 20.

The computing device 10 may be any computing device capable of at least capturing image data, processing the captured image data, and performing any and all of the methods and functions performed by any and all systems described herein. One example of the computing device 10 is a smart phone. Other examples include, but are not limited to, a cellular phone, a tablet computer, a phablet computer, a laptop computer, a personal computer (PC), an electronic gate (eGate), and any type of device having wired or wireless networking capabilities such as a personal digital assistant (PDA).

The computing device 10 may be a mobile wireless hand-held consumer computing device or may be stationary. For example, the computing device 10 may be an eGate located in a transportation hub, commercial or governmental building, or any other place where access control is necessary. Transportation hubs include, but are not limited to, airports, train stations, and bus depots.

The processor 12 executes instructions, or computer programs, stored in the memory 14. As used herein, the term processor is not limited to just those integrated circuits referred to in the art as a processor, but broadly refers to a computer, a microcontroller, a microcomputer, a programmable logic controller, an application specific integrated circuit, and any other programmable circuit capable of executing at least a portion of the functions and/or methods described herein. The above examples are not intended to limit in any way the definition and/or meaning of the term “processor.”

The memory 14 may be any non-transitory computer-readable recording medium. Non-transitory computer-readable recording media may be any tangible computer-based device implemented in any method or technology for short-term and long-term storage of information or data. Moreover, the non-transitory computer-readable recording media may be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disc and disc drive, a writeable or re-writeable optical disc and disc drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), an optical ROM disc, such as a CD-ROM or DVD-ROM disc, and disc drive or the like. Furthermore, the non-transitory computer-readable recording media may be implemented as smart cards, SIMS, any type of physical and/or virtual storage, or any other digital source such as a network or the Internet from which a computing device can read computer programs, applications or executable instructions.

The memory 14 may be used to store any type of data 32, for example, user data records. The data records are typically for users associated with the computing device 10. The data record for each user may include biometric modality data, biometric templates and personal data of the user. Biometric modalities include, but are not limited to, voice, face, finger, iris, palm, and any combination of these or other modalities. Biometric modality data is the data of a biometric modality of a person captured by the computing device 10. As used herein, capture means to record data temporarily or permanently, for example, biometric modality data of a person. Biometric modality data may be in any form including, but not limited to, image data and audio data. Image data may be a digital image, a sequence of digital images, or a video. Each digital image is included in a frame. The biometric modality data in the data record may be processed to generate at least one biometric modality template.

Additionally, the memory 14 can be used to store any type of software 33. As used herein, the term “software” is intended to encompass an executable computer program that exists permanently or temporarily on any non-transitory computer-readable recordable medium that causes the computing device 10 to perform at least a portion of the functions and/or methods described herein. Application programs are software. Software 33 includes, but is not limited to, an operating system, an Internet browser application, enrolment applications, authentication applications, user liveness detection applications, face tracking applications, applications that use pre-trained models based on machine learning algorithms, feature vector generator applications, optical flow algorithms for generating spatial displacement maps, and any other software 33 and/or any type of instructions associated with algorithms, processes, or operations for controlling the general functions and operations of the computing device 10. The software 33 may also include computer programs that implement buffers and use RAM to store temporary data.

Authentication applications enable the computing device 10 to conduct user verification and identification (1:N) transactions with any type of authentication data, where “N” is a number of candidates. Machine learning algorithm applications include at least classifiers and regressors. Classifiers and any machine learning algorithm trained model can be used to calculate confidence scores. Examples of machine learning algorithms include, but are not limited to, support vector machine learning algorithms, decision tree classifiers, linear discriminant analysis learning algorithms, and artificial neural network learning algorithms. Decision tree classifiers include, but are not limited to, random forest algorithms. Pre-trained models based on a machine learning algorithm (MLA) include, but are not limited to, a screen replay deep neural network model and a mask detection deep neural network model which can both be used to calculate passive liveness detection scores.

The process of verifying the identity of a user is known as a verification transaction. Typically, during a verification transaction a biometric template is generated from biometric modality data of a user captured during the transaction. The generated biometric template is compared against the corresponding record biometric template of the user and a matching score is calculated for the comparison. If the matching score meets or exceeds a threshold score, the identity of the user is verified as true. Alternatively, the captured user biometric modality data may be compared against the corresponding record biometric modality data to verify the identity of the user. Liveness detection applications facilitate determining whether captured data of a biometric modality of a person is of a live person.

An authentication data requirement is the biometric modality data desired to be captured during a verification or identification transaction. For the example methods described herein, the authentication data requirement is for the face of the user. However, the authentication data requirement may alternatively be for any biometric modality or any combination of biometric modalities.

Biometric modality data may be captured in any manner. For example, for voice biometric data the computing device 10 may record a user speaking. For face biometric data, the camera 22 may record image data of the face of a user by taking one or more photographs or digital images of the user, or by taking a video of the user. When the computing device 10 is stationary the camera may record image data of people approaching the computing device 10, for example, while people approach the computing device 10 located at a checkpoint in a transportation hub. The camera 22 may record a sequence of digital images at irregular or regular intervals. A video is an example of a sequence of digital images being captured at a regular interval. Captured biometric modality data may be temporarily or permanently recorded in the computing device 10 or in any device capable of communicating with the computing device 10. Alternatively, the biometric modality data may not be stored.

When a sequence of digital images is captured, the computing device 10 may extract images from the sequence and assign a time stamp to each extracted image. The rate at which images are extracted is the image extraction rate. An application, for example a face tracker application, may process the extracted digital images. The image processing rate is the number of images that can be processed within a unit of time. Some images may take more or less time to process so the image processing rate may be regular or irregular, and may be the same or different for each authentication transaction. The number of images processed for each authentication transaction may vary with the image processing rate. The image extraction rate may be greater than the image processing rate so some of the extracted images may not be processed. The data for a processed image may be stored in the memory 14 with other data generated by the computing device 10 for that processed image, or may be stored in any device capable of communicating with the computing device 10.

The gyroscope 16 and the one or more accelerometers 18 generate data regarding rotation and translation of the computing device 10 that may be communicated to the processor 12 and the memory 14 via the bus 20. The computing device 10 may alternatively not include the gyroscope 16 or the accelerometer 18, or may not include either.

The camera 22 captures image data. The camera 22 can be one or more imaging devices configured to record image data of at least a portion of the body of a user including any biometric modality of the user while utilizing the computing device 10. Moreover, the camera 22 is capable of recording image data under any lighting conditions including infrared light. The camera 22 may be integrated into the computing device 10 as one or more front-facing cameras and/or one or more rear facing cameras that each incorporates a sensor, for example and without limitation, a CCD or CMOS sensor. Alternatively, the camera 22 can be external to the computing device 10.

The user interface 24 and the display 26 allow interaction between a user and the computing device 10. The display 26 may include a visual display or monitor that displays information to a user. For example, the display 26 may be a Liquid Crystal Display (LCD), active matrix display, plasma display, or cathode ray tube (CRT). The user interface 24 may include a keypad, a keyboard, a mouse, an illuminator, a signal emitter, a microphone, and/or speakers.

Moreover, the user interface 24 and the display 26 may be integrated into a touch screen display. Accordingly, the display may also be used to show a graphical user interface, which can display various data and provide “forms” that include fields that allow for the entry of information by the user. Touching the screen at locations corresponding to the display of a graphical user interface allows the person to interact with the computing device 10 to enter data, change settings, control functions, etc. Consequently, when the touch screen is touched, the user interface 24 communicates this change to the processor 12, and settings can be changed or user entered information can be captured and stored in the memory 14. The display 26 may function as an illumination source to apply illumination to a biometric modality while image data for the biometric modality is captured.

The illuminator may project visible light, infrared light or near infrared light on a biometric modality, and the camera 22 may detect reflections of the projected light off the biometric modality. The reflections may be off of any number of points on the biometric modality. The detected reflections may be communicated as reflection data to the processor 12 and the memory 14. The processor 12 may use the reflection data to create at least a three-dimensional model of the biometric modality and a sequence of two-dimensional digital images. For example, the reflections from at least thirty thousand discrete points on the biometric modality may be detected and used to create a three-dimensional model of the biometric modality. Alternatively, or additionally, the camera 22 may include the illuminator.

The sensing device 28 may include Radio Frequency Identification (RFID) components or systems for receiving information from other devices. The sensing device 28 may alternatively, or additionally, include components with Bluetooth, Near Field Communication (NFC), infrared, or other similar capabilities. The computing device 10 may alternatively not include the sensing device 28.

The communications interface 30 may include various network cards, and circuitry implemented in software and/or hardware to enable wired and/or wireless communications with computer systems 36 and other computing devices 38 via the network 34. Communications include, for example, conducting cellular telephone calls and accessing the Internet over the network 34. By way of example, the communications interface 30 may be a digital subscriber line (DSL) card or modem, an integrated services digital network (ISDN) card, a cable modem, or a telephone modem to provide a data communication connection to a corresponding type of telephone line. As another example, the communications interface 30 may be a local area network (LAN) card (e.g., for Ethemet™ or an Asynchronous Transfer Model (ATM) network) to provide a data communication connection to a compatible LAN. As yet another example, the communications interface 30 may be a wire or a cable connecting the computing device 10 with a LAN, or with accessories such as, but not limited to, other computing devices. Further, the communications interface 30 may include peripheral interface devices, such as a Universal Serial Bus (USB) interface, a PCMCIA (Personal Computer Memory Card International Association) interface, and the like.

The communications interface 30 also allows the exchange of information across the network 34. The exchange of information may involve the transmission of radio frequency (RF) signals through an antenna (not shown). Moreover, the exchange of information may be between the computing device 10 and any other computer systems 36 and any other computing devices 38 capable of communicating over the network 34. The computer systems 36 and the computing devices 38 typically include components similar to the components included in the computing device 10. The network 34 may be a 5G communications network. Alternatively, the network 34 may be any wireless network including, but not limited to, 4G, 3G, Wi-Fi, Global System for Mobile (GSM), Enhanced Data for GSM Evolution (EDGE), and any combination of a LAN, a wide area network (WAN) and the Internet. The network 34 may also be any type of wired network or a combination of wired and wireless networks.

Examples of other computer systems 36 include computer systems of service providers such as, but not limited to, financial institutions, medical facilities, national security agencies, merchants, and authenticators. Examples of other computing devices 38 include, but are not limited to, smart phones, tablet computers, phablet computers, laptop computers, personal computers and cellular phones. The other computing devices 38 may be associated with any individual or with any type of entity including, but not limited to, commercial and non-commercial entities. The computing devices 10, 38 may alternatively be referred to as electronic devices, computer systems or information systems, while the computer systems 36 may alternatively be referred to as computing devices, electronic devices, or information systems.

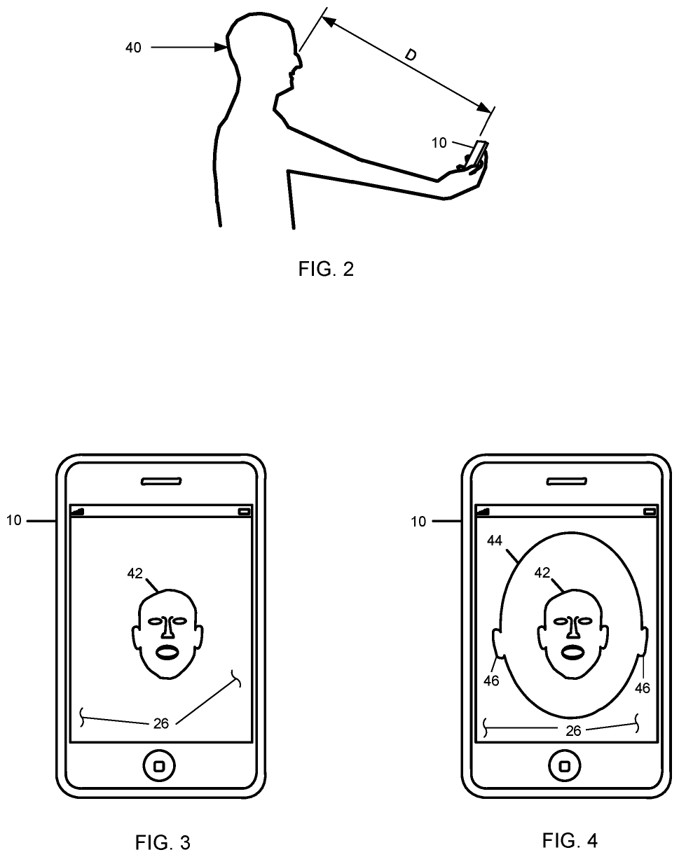

FIG. 2 is a side view of a person 40 operating the computing device 10 in which the computing device 10 is in an example initial position at a distance D from the face of the person 40. The initial position is likely to be the position in which a person naturally holds the computing device 10 to begin capturing facial image data of his or her self. Because people have different natural tendencies, the initial position of the computing device 10 is typically different for different people. The person 40 from whom facial image data is captured is referred to herein as a user. The user 40 typically operates the computing device 10 while capturing image data of his or her self. However, a person different than the user 40 may operate the computing device 10 while capturing image data of the user.

FIG. 3 is an enlarged front view of the computing device 10 displaying a facial image 42 of the user 40 when the computing device 10 is in the example initial position. The size of the displayed facial image 42 increases as the distance D decreases and decreases as the distance D increases.

While in the initial position, the computing device 10 captures facial image data of the user and temporarily stores the captured image data in the memory 14. Typically, the captured image data is a digital image. The captured facial image data is analyzed to calculate the center-to-center distance between the eyes which may be doubled to estimate the width of the head of the user 40. The width of a person's head is known as the bizygomatic width. Alternatively, the head width may be estimated in any manner. Additionally, the captured facial image data is analyzed to determine whether or not the entire face of the user is in the image data. When the entire face of the user is in the captured image data, the temporarily stored image data is discarded, a visual aid is displayed, and liveness detection is conducted.

FIG. 4 is an enlarged front view of the computing device 10 as shown in FIG. 3, further displaying an example visual aid 44. The example visual aid 44 is an oval with ear-like indicia 46 located to correspond approximately to the ears of the user 40. Alternatively, any other type indicia may be included in the visual aid 44 that facilitates approximately aligning the displayed facial image 42 and visual aid 44. Other example shapes of the visual aid 44 include, but are not limited to, a circle, a square, a rectangle, and an outline of the biometric modality desired to be captured. The visual aid 44 may be any shape defined by lines and/or curves. Each shape may include the indicia 46. The visual aid 44 is displayed after determining the entire face of the user is in the captured image data. The visual aid 44 is displayed to encourage users to move the computing device 10 such that the facial image 42 approximately aligns with the displayed visual aid 44. Thus, the visual aid 44 functions as a guide that enables users to quickly capture facial image data usable for enhancing the accuracy of user liveness detection and generating trustworthy and accurate verification transaction results.

Most users intuitively understand that the displayed facial image 42 should approximately align with the displayed visual aid 44. As a result, upon seeing the visual aid 44 most users move the computing device 10 and/or his or her self so that the displayed facial image 42 and visual aid 44 approximately align. However, some users 40 may not readily understand the displayed facial image 42 and visual aid 44 are supposed to approximately align. Consequently, a message may additionally, or alternatively, be displayed that instructs users to approximately align the displayed facial image 42 and visual aid 44. Example messages may request the user to move closer or further away from the computing device 10, or may instruct the user to keep his or her face within the visual aid 44. Additionally, the message may be displayed at the same time as the visual aid 44 or later, and may be displayed for any period of time, for example, two seconds. Alternatively, the message may be displayed until the displayed facial image 42 and visual aid 44 approximately align. Additionally, the area of the display 26 outside the visual aid 44 may be made opaque or semi-transparent in order to enhance the area within which the displayed facial image 42 is to be arranged.

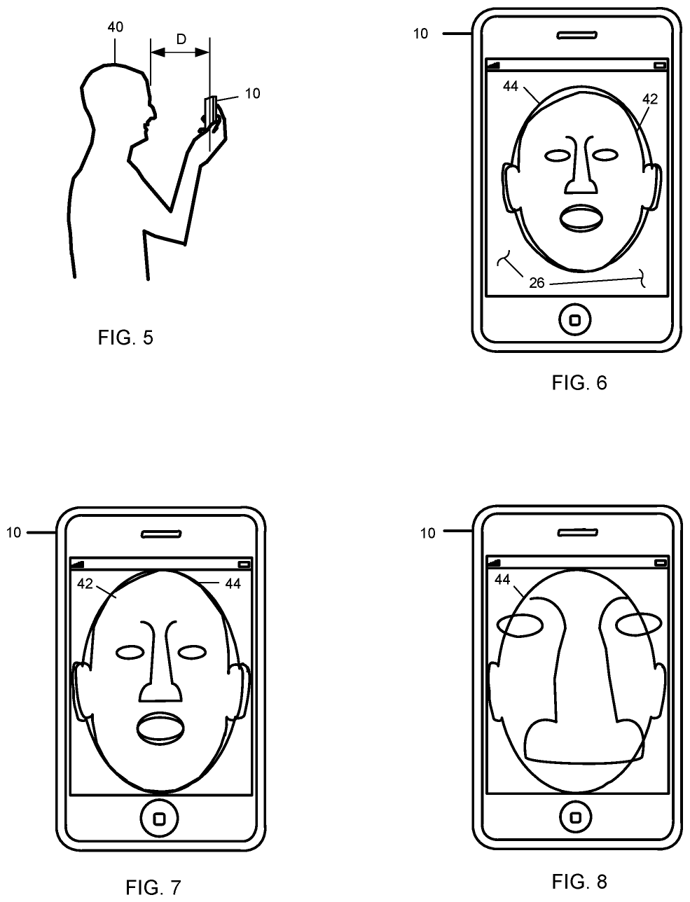

FIG. 5 is a side view of the user 40 operating the computing device 10 in which the computing device 10 is in an example first terminal position. The first terminal position is closer to the user 40 so the distance D is less than that shown in FIG. 2. After the visual aid 44 is displayed, typically users move the computing device 10. When the computing device 10 is moved such that the facial image 42 approximately aligns with the displayed visual aid 44, the computing device 10 is in the first terminal position.

FIG. 6 is an enlarged front view of the computing device 10 in the example first terminal position displaying the facial image 42 approximately aligned with the visual aid 44. Generally, the displayed facial image 42 should be close to, but not outside, the visual aid 44 in the terminal position. However, a small percentage of the facial image 42 may be allowed to extend beyond the border. A small percentage may be between about zero and ten percent.

Users 40 may move the computing device 10 in any manner from any initial position to any terminal position. For example, the computing device 10 may be translated horizontally and/or vertically, rotated clockwise and/or counterclockwise, moved through a parabolic motion, and/or any combination thereof. Regardless of the manner of movement or path taken from an initial position to a terminal position, the displayed facial image 42 should be within the visual aid 44 during movement because the computing device 10 captures facial image data of the user 40 while the computing device 10 is moving.

The captured facial image data is temporarily stored in the memory 14 for liveness detection analysis. Alternatively, the captured image data may be transmitted from the computing device 10 to another computer system 36, for example, an authentication computer system, and stored therein. While capturing image data, the computing device 10 identifies biometric characteristics of the face included in the captured image data and calculates relationships between the characteristics. Such relationships may include the distance between characteristics. For example, the distance between the tip of the nose and a center point between the eyes, the center-to-center distance between the eyes, or the distance between the tip of the nose and the center of the chin. The relationships between the facial characteristics distort as the computing device 10 is moved closer to the face of the user 40. Thus, when the computing device 10 is positioned closer to the face of the user 40 the captured facial image data is distorted more than when the computing device 10 is positioned further from the user 40, say at arms-length. When the captured image data is transmitted to an authentication computer system, the authentication computer system may also identify the biometric characteristics, calculate relationships between the characteristics, and detect liveness based on, for example, distortions of the captured facial image data.

FIG. 7 is an enlarged front view of the computing device 10 as shown in FIG. 6; however, the facial image 42 and visual aid 44 are larger. The displayed facial image 42 is somewhat distorted as evidenced by the larger nose which occupies a proportionally larger part of the image 42 while the ear indicia 46 are narrower and thus occupy a smaller part of the image 42. The facial image 42 also touches the top and bottom of the perimeter of the display 26.

Face detector applications may not be able to properly detect a face in captured image data if the entire face is not included in the image data. Moreover, image data of the entire face is required for generating trustworthy and accurate liveness detection results. Thus, the displayed facial image 42 as shown in FIG. 7 typically represents the maximum size of the facial image 42 for which image data can be captured and used to generate trustworthy and accurate liveness detection results. The position of the computing device 10 corresponding to the facial image 42 displayed in FIG. 7 is referred to herein as the maximum size position. In view of the above, it should be understood that facial image data captured when the displayed facial image 42 extends beyond the perimeter of the display 26 typically is not used for liveness detection. However, facial image data captured when a small percentage of the displayed facial image 42 extends beyond the perimeter of the display 26 may be used for liveness detection. A small percentage may be between around one and two percent.

FIG. 8 is an enlarged front view of the computing device 10 displaying the visual aid 44 as shown in FIG. 7. However, the entire face of the user is not displayed and those portions of the face that are displayed are substantially distorted. The facial image 42 was captured when the computing device 10 was very close to the face of the user, perhaps within a few inches. Facial image data captured when the facial image is as shown in FIG. 8 is not used for liveness detection because the entire face of the user is not displayed.

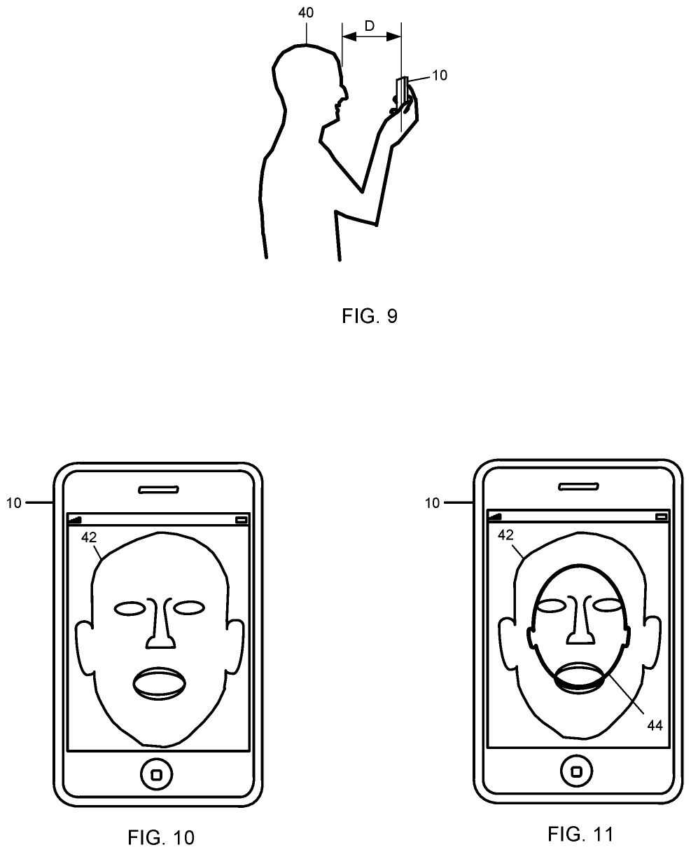

FIG. 9 is a side view of the user 40 operating the computing device 10 in which the computing device 10 is in an example second initial position which is closer to the face of the user 40 than the first initial position.

FIG. 10 is an enlarged front view of the computing device 10 displaying the facial image 42 when the computing device 10 is in the example second initial position. The example second initial position is in or around the maximum size position.

FIG. 11 is an enlarged front view of the computing device 10 displaying the facial image 42 and the example visual aid 44. However, the visual aid 44 has a different size than that shown in FIG. 4. That is, the visual aid 44 is smaller than the visual aid 44 shown in FIG. 4. Thus, it should be understood that the visual aid 44 may be displayed in a first size and a second size where the first size is larger than the second size. It should be understood that the visual aid 44 may have a different shape in addition to being smaller.

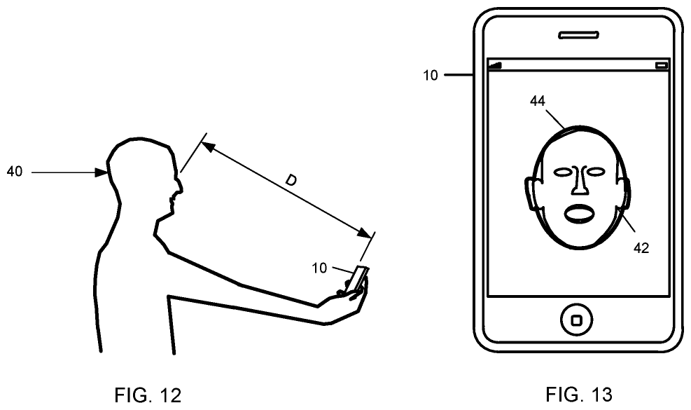

FIG. 12 is a side view of the user 40 operating the computing device 10 in an example second terminal position after the computing device 10 has been moved away from the user. The computing device 10 is moved from the second initial position to the second terminal position in response to displaying the differently sized visual aid 44.

FIG. 13 is an enlarged front view of the computing device 10 in the example second terminal position displaying the facial image 42 approximately aligned with the differently sized visual aid 44. Facial image data captured while moving the computing device 10 from the second initial position to the second terminal position may also be temporarily stored in the memory 14 and used for detecting liveness.

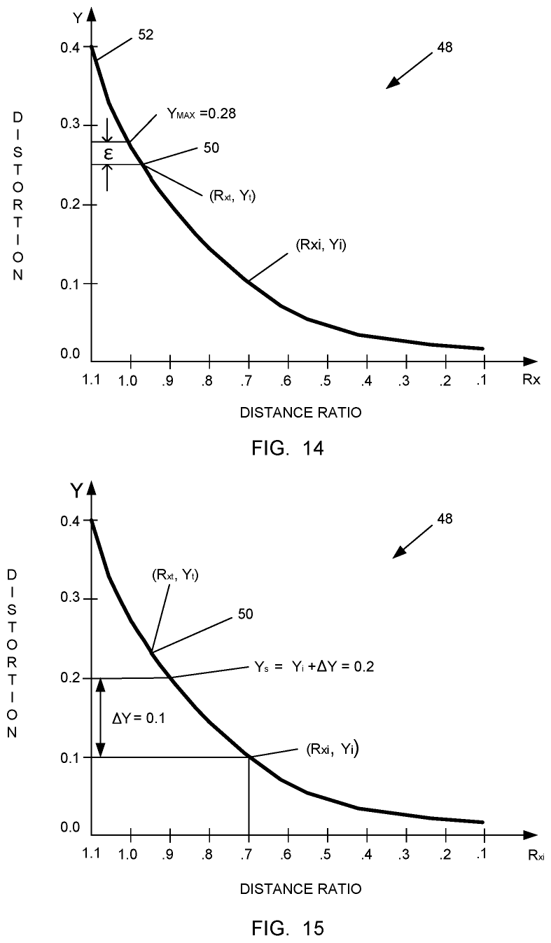

FIG. 14 is an example curve 48 illustrating the rate of change in the distortion of biometric characteristics included in captured facial image data. The Y-axis corresponds to a plane parallel to the face of the user 40 and facilitates measuring the distortion, Y, of captured facial image data in one-tenth increments. The X-axis measures the relationship between the face of the user 40 and the computing device 10 in terms of a distance ratio Rₓ.

The distance ratio Rₓ is a measurement that is inversely proportional to the distance D between the computing device 10 and the face of the user 40. The distance ratio Rₓ may be calculated as the width of the head of the user 40 divided by the width of an image data frame at various distances D from the user 40. Alternatively, the distance ratio Rₓ may be calculated in any manner that reflects the distance between the face of the user 40 and the computing device 10. At the origin, the distance ratio Rₓ is 1.1 and decreases in the positive X direction in one-tenth increments. Thus, as the distance ratio Rₓ increases the distortion of captured facial image data increases and as the distance ratio Rₓ decreases the distortion of captured facial image data decreases.

Y_{MAX} occurs on the curve 48 at a point which represents the maximum distortion value for which captured image data may be used for detecting liveness, and corresponds to the distance ratio Rₓ=1.0 which typically corresponds to the maximum size position as shown in FIG. 7. The example maximum distortion value is 0.28. However, it should be understood that the maximum distortion value Y_{MAX} varies with the computing device 10 used to capture the facial image data because the components that make up the camera 22 in each different computing device 10 are slightly different. As a result, images captured by different devices 10 have different levels of distortion and thus different maximum distortion values Y_{MAX}.

The point (Rₓₜ, Yₜ) on the curve 48 represents a terminal position of the computing device 10, for example, the first terminal position. Yₜ is the distortion value of facial image data captured in the terminal position. The distortion value Yₜ should not equal Y_{MAX} because a user may inadvertently move the computing device 10 beyond Y_{MAX} during capture which will likely result in capturing faulty image data. As a result, a tolerance value ε is used to enhance the likelihood that Yₜ does not equal Y_{MAX} and the likelihood that quality image data is captured. Quality image data may be used to enhance the accuracy and trustworthiness of liveness detection results and of authentication transaction results.

The tolerance value ε is subtracted from Y_{MAX} to define a threshold distortion value 50. Captured facial image data having a distortion value less than or equal to the threshold distortion value 50 may be quality image data, while captured facial image data with a distortion value greater than the threshold distortion value 50 is not. The tolerance value ε may be any value that facilitates capturing quality image data, for example, any value between about 0.01 and 0.05.

The point (Rₓᵢ, Yᵢ) on the curve 48 represents an initial position of the computing device 10, for example, the first initial position. Yᵢ is the distortion value of facial image data captured in the initial position. The distortion values Yᵢ and Yₜ are both less than the threshold distortion value 50, so the image data captured while the computing device was in the initial and terminal positions may be quality image data. Because the image data captured in the initial and terminal positions may be quality image data, all facial image data captured between the initial and terminal positions may also be considered quality image data.

Point 52 on the curve 48 represents the distortion value of facial image data captured when the computing device 10 is perhaps a few inches from the face of the user 40 as illustrated in FIG. 8. The distortion value at point 52 is greater than the threshold distortion value 50 so image data captured while the computing device 10 is a few inches from the face of the user 40 typically is not considered to be quality image data.

The distortion of captured image data may be calculated in any manner. For example, the distortion may be estimated based on the interalar and bizygomatic widths where the interalar width is the maximum width of the base of the nose. More specifically, a ratio R₀ between the interalar and bizygomatic widths of a user may be calculated that corresponds to zero distortion which occurs at Y=0.0. Zero distortion occurs at a theoretical distance D of infinity. However, as described herein zero distortion is approximated to occur at a distance D of about five feet.

The ratios R₀ and Rₓ may be used to estimate the distortion in image data captured at various distances D. The distortion at various distances D may be estimated as the difference between the ratios, Rₓ−R₀, divided by R₀, that is (Rₓ−R₀)/R₀. Alternatively, any other ratios may be used. For example, ratios may be calculated between the height of the head and the height of the nose, where the height of the head corresponds to the bizygomatic width. Additionally, it should be understood that any other type of calculation different than ratios may be used to estimate the distortion in image data. For the curve 48, capture of facial image data may start at about two feet from the user 40 and end at the face of the user 40.

For the example methods and systems described herein, trustworthy and accurate user liveness detection results may be calculated as a result of analyzing quality facial image data captured during a 0.1 change ΔY in distortion. Analyzing facial image data captured during a 0.1 change ΔY in distortion typically enables analyzing less image data which facilitates reducing the time required for conducting user liveness detection and thus enhances user convenience.

Although captured facial image data having a distortion value less than or equal to the threshold distortion value may be considered quality image data as described herein, it is contemplated by the present disclosure that captured image data may alternatively, or additionally, be evaluated for compliance with several different quality features in order to be considered quality biometric image data that can be used to generate accurate and trustworthy liveness detection and authentication transaction results. Such quality features include, but are not limited to, the sharpness, resolution, illumination, roll orientation, and pose deviation of an image. For each image, a quality feature value is calculated for each different quality feature. The quality feature values enable reliably judging the quality of captured biometric image data. The quality feature values calculated for each frame, as well as the captured biometric image data associated with each respective frame are stored in the memory 14.

The sharpness of captured images may be evaluated to ensure that the lines and/or edges of the images are crisp. Captured images including blurry lines and/or edges are not considered sharp. A quality feature value for the sharpness may be calculated based on the crispness of the lines and/or edges of the image.

The resolution of captured images may also be evaluated to ensure that the details therein. Distances between features included in the image may be used to determine whether or not details therein are distinguishable from each other. For example, for facial images, the distance between the eyes may be measured in pixels. When the distance between the eyes is equal to or greater than sixty-four pixels the details are considered to be distinguishable from each other. Otherwise, the details are not considered to be distinguishable from each other and the resolution is deemed inadequate. A quality feature value for the resolution is calculated based on the measured distance.

Illumination characteristics included in the captured biometric image data may additionally be evaluated to ensure that during capture the biometric modality was adequately illuminated and that the captured image does not include shadows. A quality feature value based on the illumination characteristics is also calculated for the captured biometric image data.

The roll orientation of captured biometric image data may also be evaluated to ensure that the biometric image data was captured in a position that facilitates accurately detecting user live-ness and generating trustworthy authentication results.

The quality of captured biometric image data is determined by using the quality feature values calculated for an image. The quality feature value for each different quality feature is compared against a respective threshold quality feature value. For example, the sharpness quality feature value is compared against the threshold quality feature value for sharpness. When each different quality feature value for an image satisfies the respective threshold quality feature value, the quality of the biometric image data included in the frame is adequate. As a result, the captured biometric image data may be stored in the memory 14 and may be used for detecting user live-ness and for generating trustworthy authentication transaction results. When at least one of the different quality feature values does not satisfy the respective threshold, the biometric data image quality is considered inadequate, or poor.

The different threshold feature quality values may be satisfied differently. For example, some threshold quality feature values may be satisfied when a particular quality feature value is less than or equal to the threshold quality feature value. Other threshold quality feature values may be satisfied when a particular quality feature value is equal to or greater than the threshold quality feature value. Alternatively, the threshold quality feature value may include multiple thresholds, each of which is required to be satisfied. For example, rotation of the biometric image data may be within a range between −20 and +20 degrees, the thresholds being −20 and +20 degrees.

The quality of the captured biometric image data may alternatively be determined by combining, or fusing, the quality feature values for each of the different features into a total quality feature value. The total quality feature value may be compared against a total threshold value. When the total quality feature value meets or exceeds the total threshold value, the quality of the biometric image data included in the frame is adequate. Otherwise, the quality of the biometric image data is considered inadequate, or poor.

Images captured as a video during spoof attacks are typically characterized by poor quality and unexpected changes in quality between frames. Consequently, analyzing the quality of biometric image data captured in each frame, or analyzing changes in the quality of the captured biometric data between frames, or analyzing both the quality and changes in quality may facilitate identifying spoof attacks during authentication transactions and thus facilitate enhancing security against spoof attacks.

Although the quality features described herein are for evaluating biometric data captured as an image, different quality features are typically used to evaluate different biometric modalities. For example, a quality feature used for evaluating voice biometric data is excessive background noise, for example, from traffic. However, excessive background noise used for evaluating voice biometric data cannot be used to evaluate face biometric data images.

FIG. 15 is the example curve 48 as shown in FIG. 14 further including a 0.1 change ΔY in distortion between the limits of Y=0.1 and Y=0.2. The change in distortion may be used to determine whether to display the large or small visual aid 44. The distortion value Yᵢ and the 0.1 change ΔY in distortion may be summed, i.e., Yᵢ+ΔY, to yield a distortion score Yₛ. The distortion value Yᵢ is 0.1 so the distortion score Yₛ is 0.2. When the distortion score Yₛ is less than or equal to the threshold distortion score 50, the large visual aid 44 is displayed. The image data captured by the computing device 10 while moving from the initial position into the terminal position may be considered quality image data so long as it satisfies the different threshold feature quality values described herein with regard to FIG. 14.

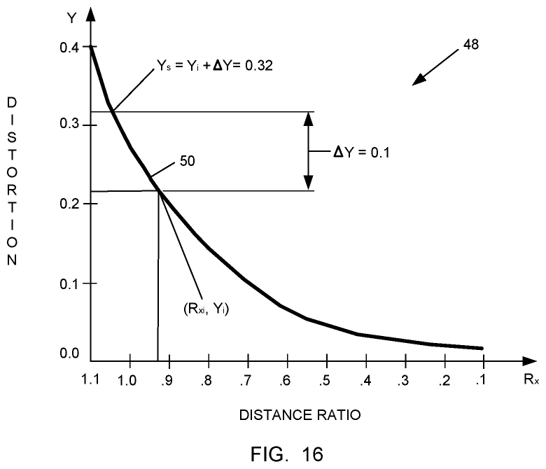

FIG. 16 is the example curve 48 as shown in FIG. 15; however, the initial position of the computing device 10 is different and results in a distortion score Yₛ that exceeds the threshold distortion value 50. Because the distortion score Yₛ exceeds the threshold distortion value 50, the 0.1 change ΔY in distortion value is subtracted from the initial distortion value Yᵢ=0.22. As a result, the small visual aid 44 is displayed. Displaying the small visual aid 44 encourages moving the computing device 10 away from the face of the user 40.

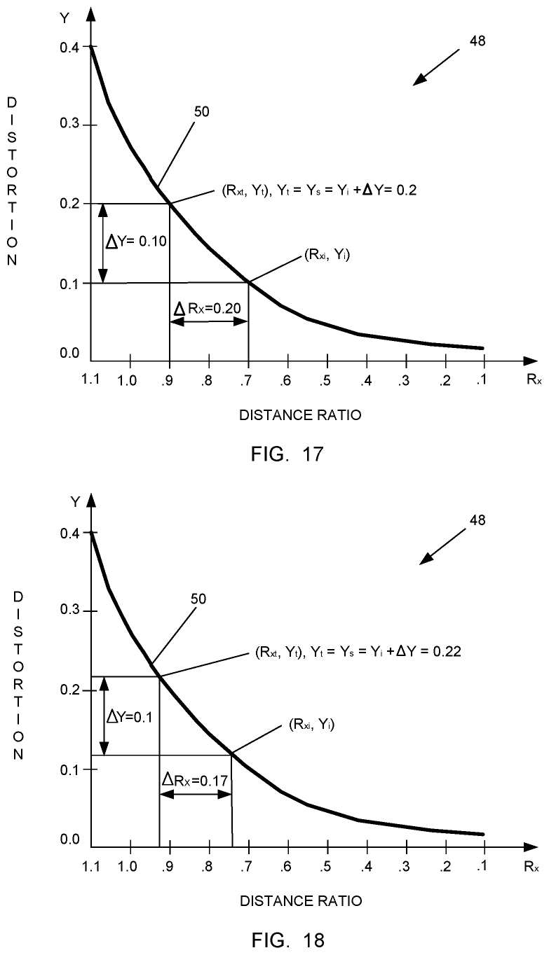

FIG. 17 is the example curve 48 as shown in FIG. 15; however, the terminal position is not coincident with the position of the threshold distortion value 50. Rather, the terminal position corresponds to the distortion score of Yₛ=0.2 which corresponds to the distance ratio Rₓ=0.9. The initial position corresponds to the distortion value Yᵢ=0.1 which corresponds to the distance ratio Rₓ=0.7. Thus, the distance ratios are calculated as 0.9 and 0.7 which have a difference of 0.20. The 0.1 change ΔY in distortion also occurs between the limits of Y=0.1 and Y=0.2. The distortion score Yₛ is 0.2 which is less than the threshold distortion value 50, so image data captured between the initial and terminal positions may be quality image data so long as it satisfies the different threshold feature quality values described herein with regard to FIG. 14.

Moving the computing device 10 between the distance ratios Rₓ=0.7 and Rₓ=0.9 enhances user convenience because the user is required to move the device 10 less while capturing image data. Moreover, less image data is typically captured which means it typically takes less time to process the data when detecting liveness which also enhances user convenience.

To facilitate capturing image data between the initial position at Rₓ=0.7 and the terminal position at Rₓ=0.9 only, a custom sized visual aid 44 may be displayed. When the distortion score Yₛ is less than or equal to the threshold distortion value 50, the size of the visual aid 44 is customized to have a width based on the greatest calculated distance ratio Rₓ which occurs in the terminal position. More specifically, because the distance ratio is calculated as the bizygomatic width divided by the width of an image data frame, the width of the custom visual aid at the terminal position can be calculated as the frame width multiplied by the greatest calculated distance ratio Rₓ=0.90.

It should be understood that the 0.1 change ΔY in distortion may be positioned to occur anywhere along the Y-axis and that each position will have a different upper and lower limit. Because quality image data need be captured only during the 0.1 change ΔY in distortion, the upper and lower limits may be used to reduce or minimize the movement required to capture image data that may be of adequate quality. More specifically, the 0.1 change ΔY in distortion may be positioned such that the limits reduce or minimize the difference between the distance ratios Rₓ in the initial and terminal positions.

FIG. 18 is the example curve 48 as shown in FIG. 17; however, the 0.1 change ΔY in distortion occurs between the limits of Y=0.12 and Y=0.22. The corresponding distance ratios are Rₓ=0.75 and Rₓ=0.92. The difference between the distance ratios is 0.17. The 0.17 difference is 0.03 less than the 0.20 difference described herein with respect to FIG. 17 which means the computing device 10 is moved through a shorter distance to capture image data that may be of adequate quality. Moving the computing device through smaller differences in the distance ratio is preferred because less movement of the computing device 10 is required to capture image data that may be of adequate quality. As a result, user convenience is enhanced.

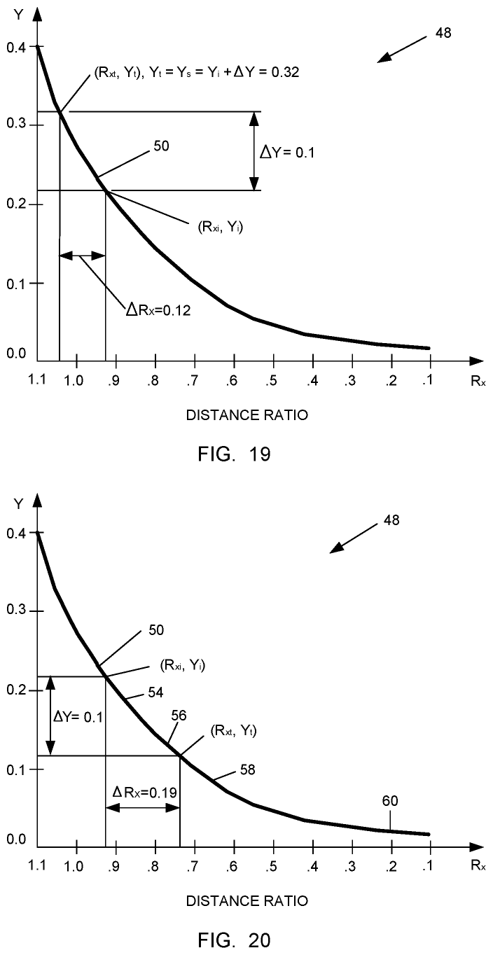

FIG. 19 is the example curve 48 as shown in FIG. 18; however, the 0.1 change ΔY in distortion occurs between the limits of Y=0.22 and Y=0.32. The distortion score Yₛ is 0.32 which is greater than the threshold distortion value 50, so image data captured for the 0.1 change ΔY in distortion between Y=0.22 and Y=0.32 is not considered quality image data. As a result, the 0.1 change ΔY in distortion is subtracted from the distortion Yᵢ and the width of the custom visual aid is calculated accordingly.

FIG. 20 is the example curve 48 as shown in FIG. 19; however, the 0.1 change ΔY in distortion is subtracted from the distortion Yᵢ such that the 0.1 change ΔY in distortion occurs between the limits of Y=0.12 and Y=0.22. The distortion values of Y =0.22 and Y =0.12 correspond to the distance ratios of Rₓ=0.92 and Rₓ=0.73. Thus, the calculated distance ratios are 0.92 and 0.73. When the 0.1 change ΔY in distortion is subtracted from the distortion value Yᵢ, the smallest calculated distance ratio is used to calculate the width of the custom visual aid. That is, the distance score of 0.73 is multiplied by the image data frame width to yield the width of the custom visual aid.

After repeatedly capturing facial image data as a result of moving the computing device 10 between the same initial position and the same terminal position, users may become habituated to the movement so may try placing the computing device 10 in an initial position that is in or around the terminal position in an effort to reduce the time required for detecting liveness. However, doing so typically does not allow for detecting a 0.1 change ΔY in distortion because many times the distortion score Yₛ exceeds the threshold distortion value 50. Consequently, doing so usually results in displaying the small visual aid 44.

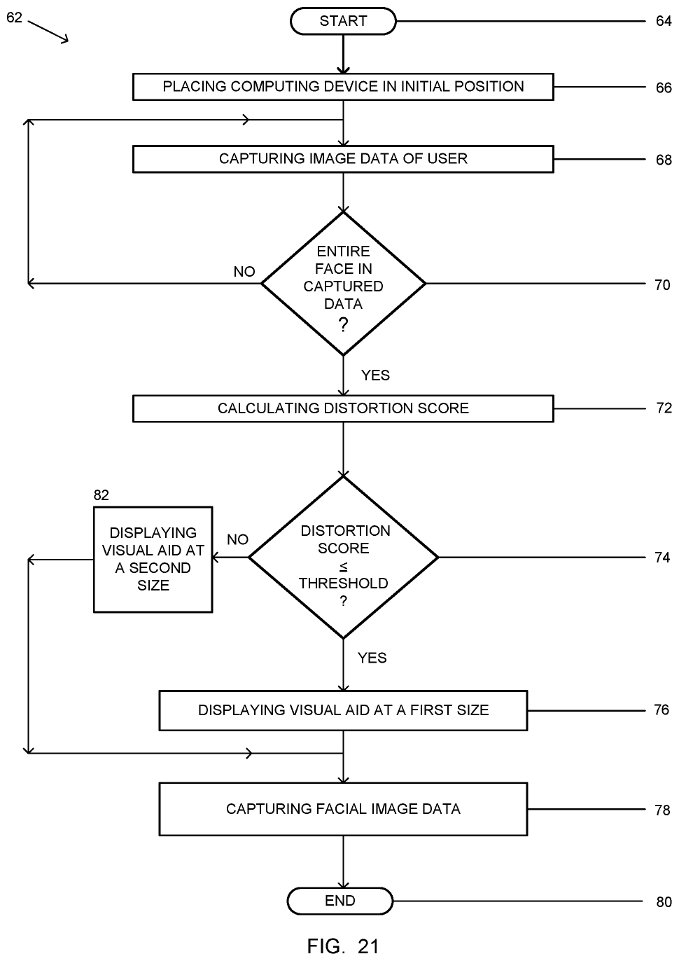

FIG. 21 is a flowchart 62 illustrating an example method of displaying a visual aid. The method starts 64 by placing 66 the computing device 10 in an initial position at a distance D from the face of the user 40, capturing 68 facial image data of the user 40, and analyzing the captured facial image data. More specifically, the facial image data is analyzed to determine 70 whether or not the entire face of the user 40 is present in the captured facial image data. If the entire face is not present 70, processing continues by capturing 68 facial image data of the user 40. However, if the entire face is present 70, processing continues by calculating 72 a distortion score Yₛ and comparing the distortion score Yₛ against the threshold distortion value 50. If the distortion score Yₛ is less than or equal to the threshold distortion value 50, the computing device 10 continues by displaying 76 the visual aid 44 at a first size and capturing 78 facial image data of the user 40 while being moved from the initial to the terminal position. Next, processing ends 80. However, if the distortion score Yₛ exceeds the threshold distortion value 50, the computing device 10 continues by displaying 82 the visual aid 44 at a second size and capturing 78 facial image data of the user while being moved from the initial to the terminal position. Next, processing ends 80.

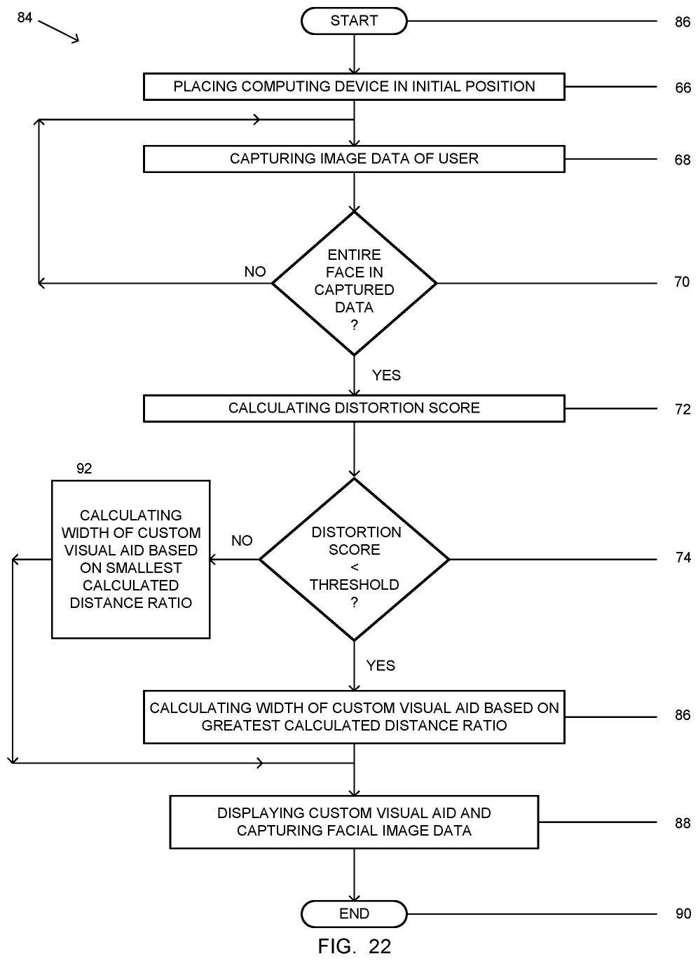

FIG. 22 is a flowchart 84 illustrating another example method of displaying a visual aid. This alternative example method is similar to that described herein with regard to FIG. 21; however, after determining 64 whether or not the distortion score Yₛ exceeds the threshold distortion value 50 the computing device displays a custom visual aid. More specifically, when the distortion score Yₛ is calculated and is less than or equal to the threshold distortion value 50, the computing device 10 continues by calculating 76 the distance ratios that correspond to the limits of the 0.1 change ΔY in distortion, calculating the width of the custom visual aid based on the greatest calculated distance ratio, and displaying 78 the custom visual aid with the calculated width while capturing 78 facial image data. Next, processing ends 80.

However, when the distortion score Yₛ exceeds the threshold distortion value 50, the computing device 10 continues by subtracting the 0.1 change ΔY in distortion from the distortion value Yₛ, calculating the distance ratios corresponding to the limits of the 0.1 change ΔY in distortion, calculating 82 the width of the custom visual aid based on the smallest calculated distance ratio, and displaying 78 the custom visual aid with the calculated width while capturing 78 facial image data. Next, processing ends 80.

The above-described methods and systems for displaying a visual aid enhance the accuracy and trustworthiness of user liveness detection results as well as verification transaction results. More specifically, in one example embodiment, after determining the entire face of a user is in captured image data, a computing device continues by calculating a distortion score and comparing the calculated distortion score against a threshold distortion value. If the distortion score is less than or equal to the threshold distortion value, the computing device continues by displaying a visual aid at a first size and capturing facial image data of the user while being moved from an initial position to a terminal position. However, if the distortion score exceeds the threshold distortion value, the computing device continues by displaying the visual aid at a second size and capturing facial image data of the user while being moved from the initial to the terminal position.

In another example embodiment, after determining whether or not the distortion score exceeds the threshold distortion value the computing device displays a custom visual aid. When the distortion score is calculated and is less than or equal to the threshold distortion value, the computing device continues by calculating the distance ratios that correspond to the limits of the 0.1 change ΔY in distortion, calculating the width of the custom visual aid based on the greatest calculated distance ratio, and displaying the custom visual aid with the calculated width while capturing facial image data. However, when the distortion score exceeds the threshold distortion value, the computing device continues by subtracting the 0.1 change ΔY in distortion from the distortion value, calculating the distance ratios corresponding to the limits of the 0.1 change ΔY in distortion, calculating the width of the custom visual aid based on the smallest calculated distance ratio, and displaying the custom visual aid with the calculated width while capturing facial image data.

As a result, in each of the above-described example embodiments, image data is captured quickly and conveniently from users which may be used to facilitate enhancing detection of spoofing attempts, accuracy and trustworthiness of user liveness detection results and of verification transaction results, and reducing time wasted and costs incurred due to successful spoofing and faulty verification transaction results. Additionally, user convenience for capturing image data with computing devices is enhanced.

Facial characteristic distortions caused by moving a two-dimensional photograph towards and away from the computing device 10 are typically insignificant or are different than those that occur in facial image data captured of a live person. Thus, distortions in captured facial image data may be used as a basis for detecting user liveness. In view of the above, it is contemplated by the present disclosure that pairs of frames from captured image data may be analyzed and used to facilitate detecting user liveness. For example, frames corresponding to image data at points 54 and 56 on the curve 48 may constitute a pair of frames, and frames corresponding to image data at points 58 and 60 on the curve 48 may constitute a different pair of frames. In order for a pair of frames to be used for detecting user liveness, the change ΔY in distortion between the points on the curve 48 corresponding to the pair of frames should be at least 0.05. Although the change ΔY in distortion is described herein as being at least 0.05, the change ΔY in distortion may alternatively be any value that facilitates generating accurate and trustworthy liveness detection results as described herein. It should be understood that the change ΔY in distortion of at least 0.05 is a threshold difference.

A region of interest is defined for each frame in a pair of frames and may be, for example, a square-shaped portion of the biometric image data in a frame. For facial image data, the region of interest may be a square-shaped portion of the facial image. A similarity transformation is applied to the image data within the region of interest to normalize the image data. Similarity transformations translate, rotate, and scale the image data within the region of interest. Similarity transformations do not change the geometry or shape of biometric data features in image data.

The normalized image data is used to create a dense pixel correspondence map also known as a spatial displacement map. More specifically, an algorithm, for example, an optical flow algorithm may be used to map every pixel in an image to create the spatial displacement map. The spatial displacement map contains depth information so it can be considered to be a three-dimensional. The spatial displacement map enables detecting user liveness based on three-dimensional biometric modality features in image data. Because depth information is considered to be an important modality that can play a key role in discriminating between live and spoofed image data, using the spatial displacement map for liveness detection as described herein enables enhancing the accuracy and trustworthiness of liveness detection results.

It is contemplated by the present disclosure that instead of using each pixel within a region of interest, pixels from areas of the face that are easier to distinguish may be used, for example, pixels from the corners of the mouth or from the corners of an eye. Alternatively, groups or blocks of pixels constituting a facial feature, for example, an eye may be mapped. Using pixels from easily distinguishable areas of the face or blocks of pixels facilitates reducing the time required for generating spatial displacement maps and the time required for detecting user liveness during authentication transactions. The mapping is a series of values that represent the change in position, or movement of pixels between frames in a pair. As a result, the mapping facilitates representing distortion values of different regions of the face between the image data in a pair of frames.

Movement of pixels between the frames as mapped is expected to be within a certain area between the frames defined by the image data, for example, a ten (10) by ten (10) square area of pixels. Alternatively, the area may be any shape, for example, a rectangle, an oval, or a circle, and may include any number of pixels. In the mapping, some pixels may move well beyond the certain area and thus represent erroneously generated data. Such erroneous data is removed from the mapping. Different spatial displacement maps may be generated for the same pair of frames. For example, a spatial displacement map may be created that represents the changes in the horizontal direction while another spatial displacement map may be created that represents changes in the vertical direction. For the example methods and algorithms described herein, the spatial displacement map includes a spatial displacement map that represents the changes in the horizontal direction and another spatial displacement map that represents changes in the vertical direction. Alternatively, the spatial displacement map may include either map.

Spatial displacement maps created from the image data in different pairs of frames, from the same and/or different sequences of images, may be used to train a MLA, for example, a deep neural network model to detect user liveness. The maps are typically created from images of different people. Moreover, spatial displacement maps may be entered or input into such trained MLAs which calculate intermediate confidence scores for the pair of frames used to create the inputted map. The intermediate confidence scores can be used for detecting user liveness. Because the spatial displacement map contains depth information, the intermediate confidence scores have a three-dimensional aspect so can be referred to as three-dimensional liveness scores.

A single intermediate confidence score is unlikely to generate an accurate and trustworthy liveness detection result. The accuracy and trustworthiness of liveness detection results is enhanced as the number of calculated intermediate confidence scores increases. Thus, a minimum number of frame pairs and corresponding intermediate confidence scores should be established in order to generate accurate and trustworthy liveness detection results. As described herein, the minimum number of frame pairs and corresponding intermediate confidence scores is twenty. However, it is contemplated by the present disclosure that any number of intermediate confidence scores, including fewer than twenty, may be used that facilitates generating accurate and trustworthy liveness detection results. An overall confidence score may be calculated from the confidence scores and used to determine whether or not the image data in a pair of frames was taken of a live person.

It is contemplated by the present disclosure that after normalizing the image data, the image data may be converted to grayscale. Doing so decreases the time required to process the spatial displacement maps by a trained MLA, for example, a deep neural network model, and thus reduces the time required to generate accurate and trustworthy liveness detection results using the methods and systems described herein. As described herein, user liveness detection is determining whether or not image data in a frame, and/or a pair of frames, was taken of a live person.

Impostors have been known to use many methods to obtain or create fraudulent data for a biometric modality of another person that can be submitted during biometric authentication transactions. For example, imposters have been known to obtain two-dimensional pictures from social networking sites which can be presented to a camera during authentication to support a false claim of identity. Imposters have also been known to make physical models of a biometric modality, such as a fingerprint using gelatin or a three-dimensional face using a custom mannequin. Moreover, imposters have been known to eavesdrop on networks during legitimate network-based biometric authentication transactions to surreptitiously obtain genuine data of a biometric modality of a person. The imposters use the obtained data for playback during fraudulent network-based authentication transactions. However, such fraudulent data are difficult to detect using known liveness detection methods.

Additionally, some liveness detection methods assess liveness based on three-dimensional (3D) characteristics of the face in a multimodal approach in which specialized camera hardware is used that captures the full 3D environment. Such camera hardware typically includes a stereo vision camera system which is able to generate a depth map representation. The stereo vision camera system is usually paired with standard red-green-blue (RGB) image and/or infrared (IR) cameras. However, such specialized equipment can be expensive, difficult to operate, and hard to implement on devices, such as smartphones, tablet computers, and laptop computers that are readily available to and easily operated by most people.

To address these problems, image data of a biometric modality of a user is captured by the computing device 10 while there is relative movement between the computing device 10 and the user 40. Pairs of frames are selected from the image data. Each frame has a distortion score and the difference between the distortion scores for each pair of frames should satisfy a threshold difference. A spatial displacement map is created for each pair of frames. The computing device 10 can use the map to calculate a confidence score for the corresponding pairs of frames and can determine whether the captured image data was taken of a live person based on the confidence scores.

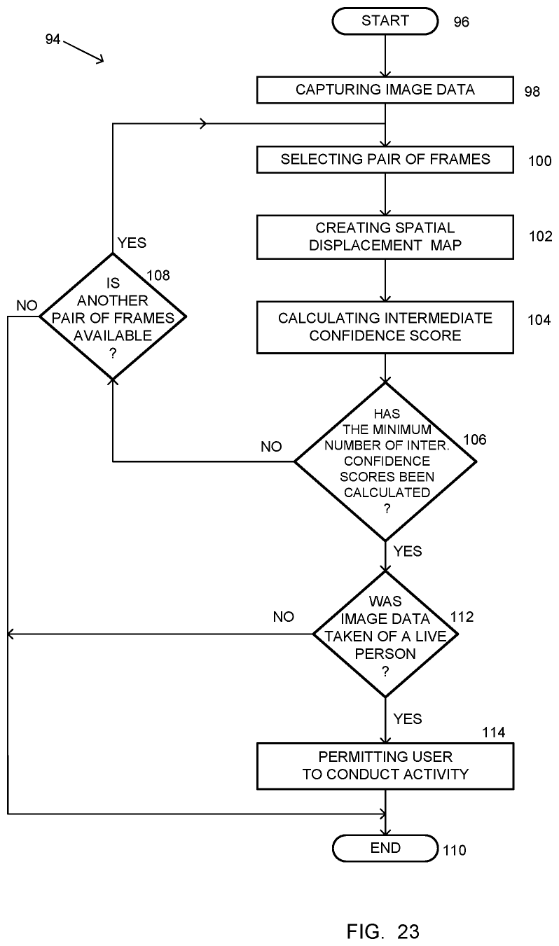

FIG. 23 is a flowchart 94 illustrating an example method and algorithm for enhancing user liveness detection results. When a user desires to conduct an activity, the user may be required to prove he or she is live before being permitted to conduct the activity. Examples of activities include, but are not limited to, accessing an area within a commercial, residential or governmental building, or conducting a network-based transaction. Example network-based transactions include, but are not limited to, buying merchandise from a merchant service provider website and accessing top secret information from a computer system. FIG. 23 illustrates example operations performed when the computing device 10 captures image data of a biometric modality of a user and determines whether the image data was taken of a live person. The example method and algorithm of FIG. 23 also includes steps that may be performed by, for example, the software 33 executed by the processor 12 of the computing device 10.

The method starts 96 with the software 33 executed by the processor 12 causing the computing device 10 to capture 98 image data of a biometric modality of a user while there is relative movement between the computing device 10 and the user 40. The relative movement may be caused by, for example, moving the computing device 10 closer to or away from the user 40, moving the user 40 closer to or away from the computing device 10, or moving both the user 40 and computing device 10 towards or away from each other. The computing device 10 may be stationary while capturing 98 image data of the user 40 as the user 40 moves towards the computing device 10. For example, the computing device 10 may be an electronic gate (eGate) at a transportation hub checkpoint that captures image data of users as they approach the checkpoint. As described herein the biometric modality is the face of the user. However, it is contemplated by the present disclosure that the image data may alternatively be of any biometric modality.

Next, the software 33 executed by the processor 12 causes the computing device 10 to select 100 a pair of frames having a change ΔY in distortion of at least 0.05 from the captured image data. Although the change ΔY in distortion is at least 0.05 in this example method, the change ΔY in distortion may alternatively be any value that facilitates generating accurate and trustworthy liveness detection results as described herein. It should be understood that the change ΔY in distortion of at least 0.05 is a threshold difference.

A region of interest is defined by the computing device 10 for each frame in the pair and may be, for example, a square-shaped portion of the face in the image data. A similarity transformation is applied by the computing device 10 to the image data within the regions of interest to normalize the image data. Similarity transformations translate, rotate, and scale the image data within the region of interest. Similarity transformations do not change the geometry or shape of biometric data features in image data.

After normalizing the image data, the computing device 10 continues by creating 102 a spatial displacement map for the selected frame pair. More specifically, the software 33 executed by the processor 12 causes the computing device 10 to calculate the position of each pixel in the facial image data in each frame and calculate the difference in position of each pixel between the frames to create 102 a spatial displacement map. The differences in position can be averaged to estimate the movement between the image data in the frames of each respective pair.

It is contemplated by the present disclosure that instead of using each pixel within a region of interest, pixels from areas of the face that are easier to distinguish may be used, for example, pixels from the corners of the mouth or from the corners of an eye. Alternatively, groups or blocks of pixels constituting a facial feature, for example, an eye may be mapped. The mapping is a series of values that represent the change in position, or movement of pixels between the images. As a result, the mapping facilitates representing distortion values of different regions of the face between the two images in the pair of selected frames.

Next, the software 33, for example a machine learning algorithm trained model, executed by the processor 12 causes the computing device 10 to calculate 104 an intermediate confidence score based on the spatial displacement map. The spatial displacement map contains depth information so it can be considered to be a three-dimensional depth map. Because depth information is considered to be an important modality that can play a key role in discriminating between live and spoofed image data, using the spatial displacement map to calculate the intermediate confidence scores as described herein enables enhancing the accuracy and trustworthiness of liveness detection results. The intermediate confidence score may also be referred to as a three-dimensional liveness score.

For this example method and algorithm, the spatial displacement map includes a spatial displacement map that represents the changes in the horizontal direction and a another spatial displacement map that represents changes in the vertical direction. Alternatively, the spatial displacement map may include a map showing either the vertical or horizontal changes.

It is unlikely that a single intermediate confidence score generated from the image data of a single pair of frames will yield accurate and trustworthy liveness detection results. The accuracy and trustworthiness of liveness detection results is enhanced as the number of calculated intermediate confidence scores increases. Thus, a minimum number of intermediate confidence scores should be predetermined in order to generate accurate and trustworthy liveness detection results. As described herein, the predetermined minimum number of intermediate confidence scores can be, for example, twenty. However, it is contemplated by the present disclosure that the predetermined minimum number may be any number of intermediate confidence scores, including fewer than twenty, that facilitates determining whether or not captured image data is of a live person.

Next, the software executed by the processor 12 causes the computing device 10 to determine 106 whether or not the minimum number of intermediate confidence scores has been calculated. More specifically, the total number of calculated intermediate confidence scores is determined and compared against the predetermined minimum number. If the total is less than the predetermined minimum number, the minimum number of intermediate confidence scores has not been calculated. As a result, the computing device 10 determines 108 whether or not another pair of frames having a change ΔY in distortion of at least 0.05 is available that has not been previously selected. If so, another pair of frames is selected 100. Otherwise, processing ends 110.

If the total is at least equal to the predetermined minimum number, the computing device 10 determines 112 whether or not the image data in the selected pair was taken of a live person based on the calculated intermediate confidence scores. More specifically, software 33 executed by the processor 12 causes the computing device 10 to calculate an overall confidence score using all of the calculated intermediate confidence scores. When the overall confidence score is equal to or greater than a threshold score, the image data in the selected pair is considered to be of a live person so the user is permitted 114 to conduct the desired activity. However, when the overall confidence score is less than the threshold score, the image data in the selected pair is considered to be of an imposter so the user is not permitted 114 to conduct the desired activity and processing ends 110.

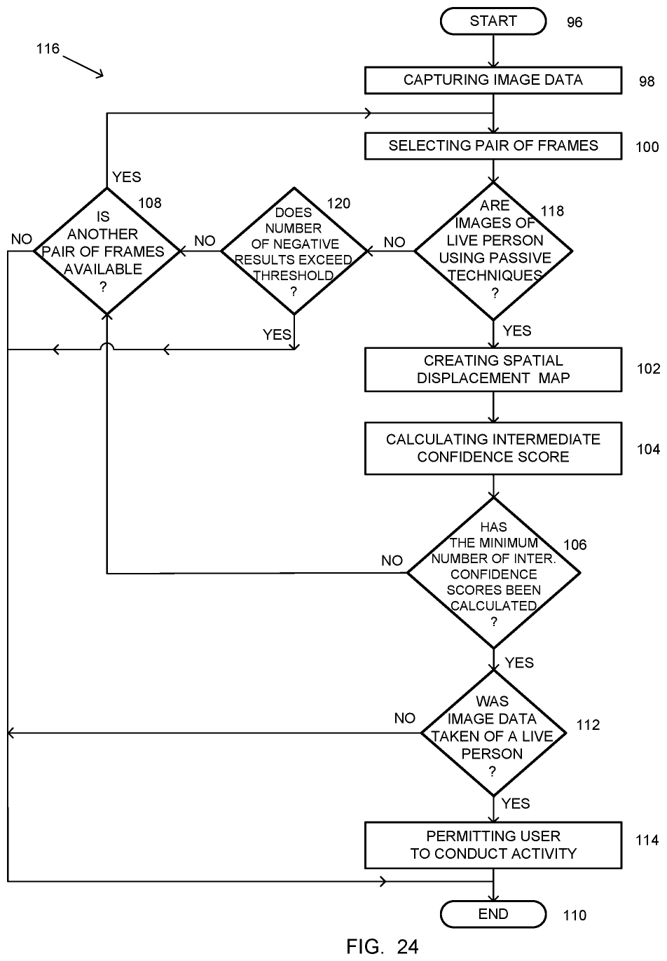

The information shown in FIG. 24 is the same information shown in FIG. 23 as described in more detail below. As such, features illustrated in FIG. 24 that are identical to features illustrated in FIG. 23 are identified using the same reference numerals used in FIG. 23.

FIG. 24 is a flowchart 116 illustrating an alternative example method and algorithm for enhancing user liveness detection results. This alternative example method and algorithm are similar to that described herein with regard to FIG. 23; however, after selecting 100 a pair of frames with a change in distortion of at least 0.05, the image data in the selected frames is processed using passive liveness detection techniques to determine 118 whether or not the image data was taken of a live person. In this example method, passive liveness detection techniques are used to quickly filter out or eliminate image data that likely cannot be used to generate accurate and trustworthy liveness detection results.

More specifically, after a pair of frames is selected 100 the software 33 executed by the processor 12 causes the computing device 10 to analyze the image data in the selected pair of frames for artifacts indicative of a spoofing attack. Artifacts include, but are not limited to, a mask in an image, an imbalance in color in an image, less resonance in the facial area of the image compared to other areas of the image, and anything that is not a face, for example, a TV, car radio, or a computer printer.

Machine learning algorithm trained models like deep neural network models may be used to detect artifacts. For example, software 33, like a screen replay deep neural network model, may be executed by the processor 12 to cause the computing device 10 to generate a passive liveness detection score for each frame from the respective frame's image data. The score may be used to determine if the image data in either frame was taken of a replayed picture or a replayed video. Additionally, or alternatively, software 33, like a mask detection deep neural network model, may be executed by the processor 12 to cause the computing device 10 to generate a passive liveness detection score for each frame from the respective frame's image data. The score may be used to determine if the image data in either frame was taken of a mask instead of a face. If the generated passive liveness detection score for the image data in each frame is at least equal to a corresponding threshold score, the image data in each frame is considered to have been taken of a live person 118. As a result, the computing device 10 continues by performing steps 102, 104, 106, 108, and 110 as described herein with regard to the flowchart illustrated in FIG. 23.

However, a passive liveness detection score less than the corresponding threshold score for the image data in either of the selected frames, may indicate there was an error processing the image data or that the image data includes artifacts indicative of a spoofing attack. Such a result is referred to herein as a negative result. A negative result is generated if any of the scores is less than a corresponding threshold score. The frames including the image data from which the negative result was calculated are discarded.

Next, the computing device 10 continues by determining 120 whether or not the number of negative results exceeds a threshold number. If the number of negative results is less than the threshold number, processing continues by determining 108 whether or not another pair of frames is available having a change ΔY in distortion of at least 0.05 is available that has not been previously selected. If so, another pair of frames is selected 100. Otherwise, processing ends 110. However, if the number of negative results is at least equal to the threshold number, the image data in the selected frames is considered to include artifacts indicative of a spoofing attack. As a result, the image data is considered to be of an imposter so processing ends 110.

In this example method, the threshold number is three negative results. However, it is contemplated by the present disclosure that the threshold number may alternatively be any number that facilitates quickly generating accurate and trustworthy liveness detection results.

After calculating the minimum number of intermediate confidence scores in step 106, the computing device 10 continues by determining 112 whether or not the captured image data of each frame was taken of a live person. More specifically, an overall confidence score is calculated from the intermediate confidence scores and the passive liveness detection scores, and is compared against an overall threshold score. The overall confidence score may be calculated in any manner using the intermediate confidence scores and the passive liveness detection scores. For example, the scores calculated for each different passive liveness detection technique may be averaged separately. So, when passive liveness detection is conducted for both replays and masks the scores calculated for replay detection can be averaged and the scores calculated for mask detection can also be averaged. Additionally, the intermediate confidence scores can be averaged. The overall confidence score can be calculated by multiplying the average intermediate confidence score by all of the average passive liveness detection scores. That is, the intermediate confidence score can be multiplied by the average replay passive liveness detection score and by the average mask passive liveness detection score.

If the overall confidence score is at least equal to the overall threshold score the image data is considered 112 to have been taken of a live person, so processing continues by permitting 114 the user to conduct the desired activity. Otherwise, the image data is considered to be of an imposter so the user is not permitted to conduct the desired activity and processing ends 110.

Although two different deep neural network models are described herein with regard to the flowchart 116 illustrated in FIG. 24, it is contemplated by the present disclosure that any number and any type of machine learning algorithm trained models may be used to calculate passive liveness detection scores.

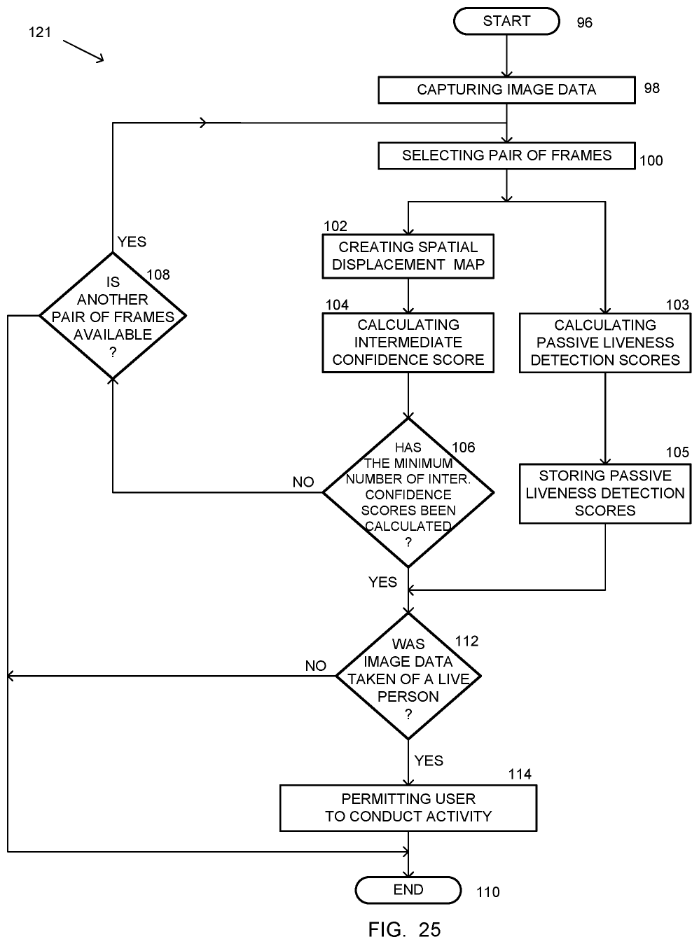

Some of the information shown in FIG. 25 is identical to some of the information shown in FIGS. 23 and 24 as described in more detail below. Features illustrated in FIG. 25 that are identical to features illustrated in FIGS. 23 and 24 are identified using the same reference numerals used in FIGS. 23 and 24.

FIG. 25 is a flowchart 121 illustrating another alternative example method and algorithm for enhancing user liveness detection results. This alternative example method and algorithm are similar to that described herein with regard to FIG. 24; however, passive liveness detection techniques are not used to filter out or eliminate image data. Rather, passive liveness techniques are used to calculate passive liveness detection scores for each frame in a pair at or about the same time the intermediate confidence score is calculated in step 104. That is, the passive liveness scores and the intermediate confidence scores can be calculated in parallel. More specifically, after a pair of frames is selected the software 33 executed by the processor 12 causes the computing device 10 to calculate 103 a first passive liveness score for each frame using the image data in the respective frame. The first passive liveness detection score may be for detecting screen replays. Additionally, the computing device 10 calculates 103 a second passive liveness score for each frame using the image data in the respective frame. The second passive liveness detection score may be for detecting masks. The computing device 10 can store 105 the calculated passive liveness detection scores in the memory 14.

It is contemplated by the present disclosure that the passive liveness scores can be calculated at or about the same time the intermediate confidence score is calculated in step 104. Alternatively, the passive liveness detection scores can be calculated any time before the intermediate confidence score or after. However, if calculated after, the passive liveness detection scores should also be calculated before determining 112 whether the image data was taken of a live person. Steps 102, 104, 106, 108, and 110 are conducted as described herein with respect to the flowcharts 94 and 116 illustrated in FIGS. 23 and 24, respectively.

After determining 106 that the minimum number of intermediate confidence scores have been calculated, the computing device 10 determines 112 whether or not the captured image data of each frame was taken of a live person. More specifically, an overall confidence score is calculated from the intermediate confidence scores and the passive liveness detection scores, and is compared against an overall threshold score.

The overall confidence score may be calculated in any manner using the intermediate confidence scores and the passive liveness detection scores. For example, the stored first passive liveness detection scores can be averaged and the stored second passive liveness detection scores can be averaged. Additionally, the intermediate confidence scores can be averaged. The overall confidence score can be calculated by multiplying the average intermediate confidence score by the average first passive liveness detection score and the average second passive liveness detection score.

If the overall confidence score is at least equal to the overall threshold score the image data in the selected frames is considered 112 to have been taken of a live person, so processing continues by permitting 114 the user to conduct the desired activity. Otherwise, the image data in the selected frames is considered to be of an imposter so the user is not permitted to conduct the desired activity and processing ends 110.

In the example method described herein with respect to the flowchart illustrated in FIG. 24, passive liveness detection techniques were used to analyze captured image data to quickly filter out or eliminate image data that likely cannot be used to generate accurate and trustworthy liveness detection results. It is contemplated by the present disclosure that any number of liveness detection techniques can be used to enhance quickly eliminating image data that likely cannot be used for generating accurate and trustworthy liveness detection results. Example liveness detection techniques that may be used to eliminate image data include, but are not limited to, determining that the same person is in each image, determining that the facial image data in each frame is continuous, determining that the image data in each frame is of adequate quality, determining that the computing device moved during capture, and conducting one or more types of passive liveness detection.

Determining that the same person is in each image can involve conducting a biometric verification transaction using the image data in a selected pair of frames. More specifically, a biometric template for the image data in each frame may be created, the created templates can be compared against each other, and a matching score can be calculated for the comparison. If the matching score meets or exceeds a threshold score the images are determined to be of the same person.

Images in a pair of frames are considered to be continuous when factors related to positioning are similar and the images comply with the quality features described herein. Factors related to positioning include, but are not limited to, whether or not the images are in a substantially similar position in their respective frames. For example, images that are centered within their frames, that are in the same corner of the frame, that are on the same side of the frame, or that are both on the top or bottom of their respective frames are considered to be continuous between frames. However, images that are not both centered within their respective frames, that are in opposite corners of their frames, that are on opposite sides of their frames, or are otherwise substantially positioned differently within their frames are not considered continuous.

Additionally, in order to be continuous, both images in a pair of frames also need to comply with the quality features described herein. The differences between the quality features in each image cannot be significant. For example, if one image in the pair has a high degree of resolution while the other image is fuzzy the images are not considered to be continuous. As another example, if one image in a pair is highly illuminated while the other image has little illumination the images are not considered to be continuous. Images that are not continuous typically are not used to detect user liveness.

Data collected by the accelerometer 18 and the gyroscope 16 to indicate the computing device 10 moved in some fashion during capture will typically be adequate for use in detecting liveness. However, if the accelerometer 18 and gyroscope 16 data indicate there was no movement during capture then the images typically are not used for detecting liveness. It is preferred that while the computing device captures the sequence of images, data collected by the accelerometer 18 and gyroscope 16 may be used to ensure motion of the computing device 10 comports with the visual aid displayed during capture. For example, when the small visual aid is displayed the computing device 10 is to be moved away from the person 40. If the data collected by the accelerometer 18 and gyroscope 16 agrees with such motion then the images in the pair may be used to detect user liveness. It is contemplated by the present disclosure that when relative motion between the computing device 10 and the user 40 occurs but movement is not sensed by the accelerometer and gyroscope while capturing 98 image data, movement of the computing device 10 cannot be a factor considered in determining whether or not the captured image data can be used for liveness detection.

Image data from a pair of selected frames that is not eliminated by any of the above liveness detection techniques and passive liveness detection techniques is likely to generate accurate and trustworthy liveness detection results. Thus, the image data from a pair of selected frames is likely to generate accurate and trustworthy liveness detection results if the same person is in each image, the facial image is continuous, the images are of adequate quality, the computing device moved during capture, and the images are determined to be of a live person using passive liveness techniques. It should be understood that any combination of these liveness detection techniques may alternatively be used. Moreover, additional liveness techniques may be used that enhances the accuracy and trustworthiness of liveness detection results as well as verification transaction results.

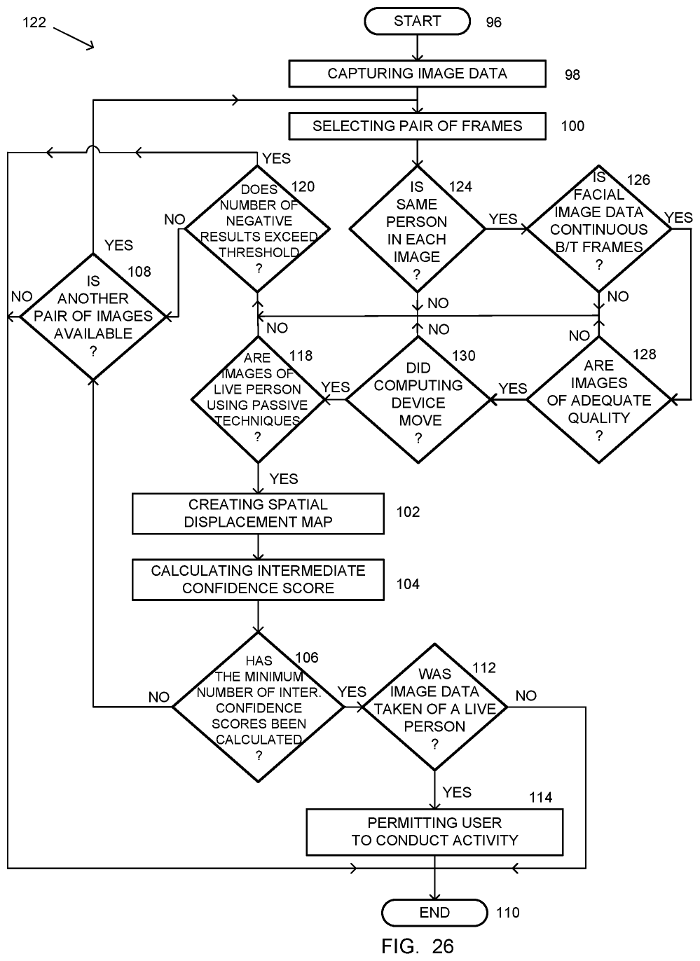

The information shown in FIG. 26 is the same information shown in FIG. 24 as described in more detail below. As such, features illustrated in FIG. 26 that are identical to features illustrated in FIG. 24 are identified using the same reference numerals used in FIG. 24.

FIG. 26 is a flowchart 122 illustrating yet another alternative example method and algorithm for enhancing user liveness detection results. This alternative example method is similar to that described herein with regard to FIG. 24; however, after selecting a pair of frames the image data is processed by additional liveness detection techniques. More specifically, after the pair of frames is selected 100 the software 33 executed by the processor 12 causes the computing device 10 to analyze the image data in each frame to determine 124 whether the same person is in each frame. A biometric template for each image is created and the created templates are compared against each other.

A matching score is calculated for the comparison. If the matching score is less than a threshold score, the result is considered a negative result so the computing device 10 continues by determining 120 whether or not the number of negative results exceeds the threshold number. If the matching score meets or exceeds the threshold number, the image data is determined to be of the same person so the computing device 10 continues by determining 126 whether or not facial image data is continuous between the selected frames.

Image data is considered to be continuous when factors related to positioning are similar and quality features are complied with. Factors related to positioning include, but are not limited to, whether or not the images are in a substantially similar position in their respective frames. When the images are not considered to be continuous 126 the result is considered a negative result and processing continues by determining 120 whether or not the number of negative results exceeds the threshold number. Additionally, the selected frames can be discarded. Otherwise, when the image data is considered to be continuous 126 the computing device 10 continues by determining 128 whether or not each of the images is of adequate quality.

More specifically, the image data in each of the selected frames is evaluated for compliance with several different quality features including, but not limited to, the sharpness, resolution, illumination, roll orientation, and facial pose deviation of each image. For each image, a quality feature value is calculated for each different quality feature. The quality feature values enable reliably judging the quality of the captured images. The quality feature values calculated for each image, as well as the captured images can be stored in the memory 14. When the image data in either of the selected frames does not comply with the quality features, the result is considered a negative result and processing continues by determining 120 whether or not the number of negative results exceeds the threshold number. Additionally, the image data of the selected frames can be discarded. Otherwise, when the image data in both selected frames is in compliance with the quality features, the computing device 10 continues by determining 130 whether or not the computing device 10 moved in some fashion during capture. Any movement is acceptable.

If accelerometer 18 and gyroscope 16 data generated while capturing 98 the image data indicate there was no movement then the captured image data cannot be used for detecting liveness. The result is considered a negative result and processing continues by determining 120 whether or not the number of negative results exceeds the threshold number. Additionally, the image data of the selected frames can be discarded. When relative motion between the computing device 10 and the user 40 occurs but movement is not sensed by the accelerometer 18 and gyroscope 16 while capturing 98 image data, movement of the computing device 10 cannot be a factor considered in determining whether or not the captured image data can be used for liveness detection.

However, when accelerometer 18 and gyroscope 16 data generated while capturing 98 the image data indicate there was movement the captured image data can be used for detecting liveness. As a result, the computing device 10 continues by determining 118 whether or not the image data in the selected frames is of a live person using passive liveness techniques as described herein with regard to the flowchart 116 illustrated in FIG. 24. Steps 102, 104, 106, 108, 110, 112, and 114 are conducted as described herein with regard to the flowchart 116 illustrated in FIG. 24.

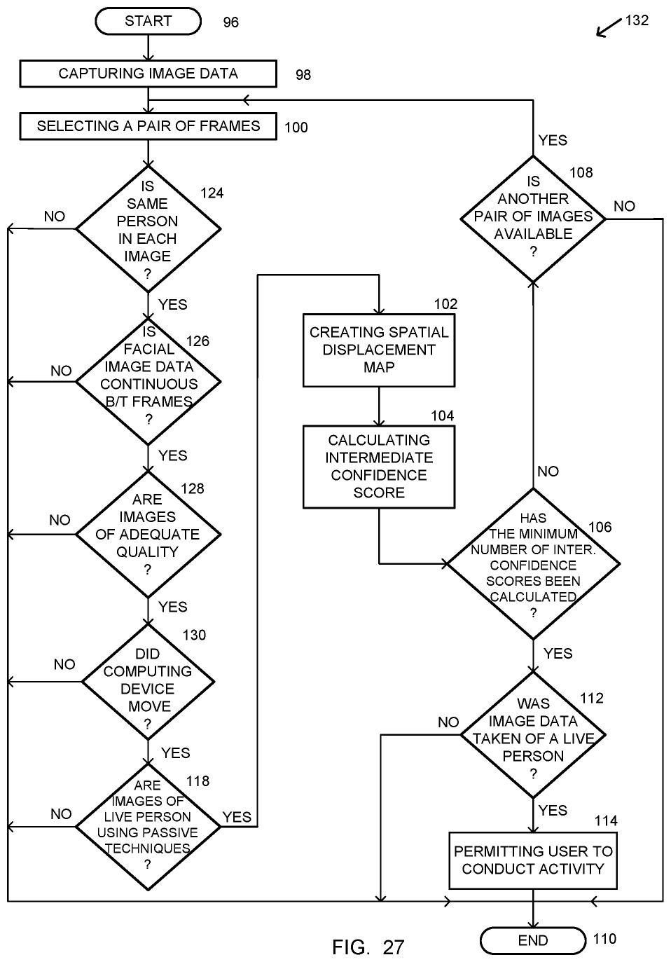

The information shown in FIG. 27 is the same information shown in FIG. 26 as described in more detail below. As such, features illustrated in FIG. 27 that are identical to features illustrated in FIG. 26 are identified using the same reference numerals used in FIG. 26.

FIG. 27 is a flowchart 132 illustrating yet another alternative example method and algorithm for enhancing user liveness detection results. This alternative example method is similar to that described herein with regard to FIG. 26; however, when the result of any of steps 124, 126, 128, 130, and 118 is a negative result processing ends 110.

Using the methods and algorithms for enhancing liveness detection results facilitates enhancing detection of spoofing attempts, accuracy and trustworthiness of user liveness detection results and of verification transaction results, and reducing time wasted and costs incurred due to successful spoofing and faulty verification transaction results. Additionally, liveness detection techniques based on depth maps may be implemented using inexpensive nonspecialized equipment that is readily available to and easily operated by most people. Moreover, user convenience for capturing image data with computing devices is enhanced.

Although the example methods and algorithms are described herein as being conducted by the computing device 10, it is contemplated by the present disclosure that the example methods and algorithms may be conducted partly on the computing device 10 and partly on other computing devices 38 and computer systems 36 operable to communicate with the computing device 10 over the network 34. More specifically, any step or any combination of steps in the flowcharts 62, 84, 94, 116, 121, 122, and 132 described herein may be conducted by the computing device 10 or other computing devices 38 and computer systems 36 operable to communicate with the computing device 10 over the network 34. For example, with reference to the flowchart 116 illustrated in FIG. 24, steps 96, 98, 100, 102, 104, 108, 118, and 120 can be conducted by the computing device 10 while steps 112, 114, and 110 can be conducted by another computing device 38 and/or a computer system 36 operable to communicate with the computing device 10 over the network 34. Alternatively, steps 96 and 98 may be conducted by the computing device 10 and all other steps included in the flowchart 116 may be conducted by another computing device 38 and/or computer system 36 operable to communicate with the computing device 10 over the network 34.

As another example, with reference to the flowchart 122 illustrated in FIG. 26, steps 96, 98, 100, 102, 104, 106, 108, 118, 120, 124, 126, 128 and 130 may be conducted by the computing device 10 while steps 112, 114 and 110 can be conducted by another computing device 38 and/or computer system 36 operable to communicate with the computing device 10 over the network 34. Alternatively, steps 96, 98, and 100 can be conducted by the computing device 10 while all other steps included in the flowchart 121 may be conducted by another computing device 38 and/or computer system 36 operable to communicate with the computing device 10 over the network 34.

Moreover, the example methods described herein may be conducted entirely on the other computer systems 36 and other computing devices 38. Thus, it should be understood that it is contemplated by the present disclosure that the example methods and algorithms described herein may be conducted on any combination of computers, computer systems 36, and computing devices 38. Furthermore, data described herein as being stored in the memory 14 may alternatively be stored in any computer system 36 or computing device 38 operable to communicate with the computing device 10 over the network 34.

Additionally, the example methods and algorithms described herein may be implemented with any number and organization of computer program components. Thus, the methods described herein are not limited to specific computer-executable instructions. Alternative example methods may include different computer-executable instructions or components having more or less functionality than described herein.

The example methods and/or algorithms described above should not be considered to imply a fixed order for performing the method and/or algorithm steps. Rather, the method and/or algorithm steps may be performed in any order that is practicable, including simultaneous performance of at least some steps. Moreover, the method and/or algorithm steps may be performed in real time or in near real time. It should be understood that, for any method and/or algorithm described herein, there can be additional, fewer, or alternative steps performed in similar or alternative orders, or in parallel, within the scope of the various embodiments, unless otherwise stated. Furthermore, the invention is not limited to the embodiments of the methods and/or algorithms described above in detail. Rather, other variations of the methods and/or algorithms may be utilized within the spirit and scope of the claims.

What is claimed is:

1. A method for enhancing user liveness detection comprising the steps of:
capturing, by a camera in an electronic device, facial image data of a user while there is relative movement between the electronic device and the user;
selecting pairs of frames from the captured facial image data, each frame having a distortion score, wherein a difference between the distortion scores for each pair at least equals a threshold difference;
creating, by the electronic device, a spatial displacement map for each pair of frames;
calculating, by the electronic device, a confidence score for each pair of frames based on the displacement map created for each respective pair of frames; and
determining whether the captured facial image data was taken of a live person based on the confidence scores.

2. The method according to claim 1, the creating a special displacement map step comprising:
calculating the position of each pixel in the facial image data in each frame of each pair; and
calculating the difference in position of each pixel between the frames of each respective pair.

3. The method according to claim 1, the creating a special displacement map step comprising:
calculating the position of each pixel within different blocks of pixels in the facial image data in each frame of each pair;
calculating the difference in position of each block of pixels between the frames of each respective pair; and
averaging the calculated differences in position to estimate the movement between the facial image data in the frames of each respective frame pair.

4. The method according to claim 1, the step of calculating the confidence score comprising:
inputting the spatial displacement map created for a pair of the selected frames into a machine learning algorithm (MLA); and
calculating a confidence score for the pair of frames using the MLA.

5. The method according to claim 1, the determining step further comprising:
calculating an overall confidence score from the confidence scores;
comparing the overall confidence score against a threshold confidence score; and
determining the facial image data was taken of a live person when the overall confidence score at least equals the threshold score.

6. The method according to claim 1, further comprising calculating the distortion score for each frame based on an interalar width and a bizygomatic width, wherein the interalar width is the maximum width of the base of the nose of the user.

7. The method according to claim 1 further comprising
calculating a liveness detection score for the image data in each frame using at least one of a first machine learning algorithm (MLA) trained model and a second MLA trained model.

8. An electronic device for enhanced liveness detection comprising:
a camera;
a processor; and
a memory configured to store data, the electronic device being associated with a network and the memory being in communication with the processor and having instructions stored thereon which, when read and executed by the processor, cause the electronic device to:
capture facial image data of a user while there is relative movement between the electronic device and the user;
select pairs of frames from the captured facial image data, each frame having a distortion score, wherein a difference between the distortion scores for each pair at least equals a threshold difference;
create a spatial displacement map for each pair of frames;
calculate a confidence score for each pair of frames based on the displacement map created for each respective pair of frames; and
determine whether the captured facial image data was taken of a live person based on the confidence scores.

9. The electronic device according to claim 8, wherein the instructions when executed by the processor further cause the electronic device to:
calculate the position of each pixel in the facial image data in each frame of each pair; and
calculate the difference in position of each pixel between the frames of each respective pair.

10. The electronic device according to claim 8, wherein the instructions when executed by the processor further cause the electronic device to:
calculate the position of each pixel within different blocks of pixels in the facial image data in each frame of each pair;
calculate the difference in position of each block of pixels between the frames of each respective pair; and
average the calculated differences in position to estimate the movement between the facial image data in the frames of each respective frame pair.

11. The electronic device according to claim 8, wherein the instructions when executed by the processor further cause the electronic device to:
input the spatial displacement map created for a pair of the selected frames into a machine learning algorithm (MLA); and
calculate a confidence score for the pair of frames using the MLA.

12. The electronic device according to claim 8, wherein the instructions when executed by the processor further cause the electronic device to:
calculate an overall confidence score from the confidence scores;
compare the overall confidence score against a threshold confidence score; and
determine the facial image data was taken of a live person when the overall confidence score at least equals the threshold score.

13. The electronic device according to claim 8, wherein the instructions when executed by the processor further cause the electronic device to calculate the distortion score for each frame based on an interalar width and a bizygomatic width, wherein the interalar width is the maximum width of the base of the nose of the user.

14. The electronic device according to claim 8, wherein the instructions when executed by the processor further cause the electronic device to calculate a liveness detection score for the image data in each frame using at least one of a first machine learning algorithm (MLA) trained model and a second MLA trained model.

15. A non-transitory computer-readable recording medium in an electronic device for enhanced liveness detection, the non-transitory computer-readable recording medium storing instructions which when executed by a hardware processor cause the non-transitory recording medium to perform steps comprising:
capturing facial image data of a user while there is relative movement between the electronic device and the user;
selecting pairs of frames from the captured facial image data, each frame having a distortion score, wherein a difference between the distortion scores for each pair at least equals a threshold difference;
creating a spatial displacement map for each pair of frames;
calculating a confidence score for each pair of frames based on the displacement map created for each respective pair of frames; and
determining whether the captured facial image data was taken of a live person based on the confidence scores.

16. The non-transitory computer-readable recording medium according to claim 15, wherein the creating a spatial displacement map step comprises:
calculating the position of each pixel in the facial image data in each frame of each pair; and
calculating the difference in position of each pixel between the frames of each respective pair.

17. The non-transitory computer-readable recording medium according to claim 15, wherein the creating a spatial displacement map step comprises:
calculating the position of each pixel within different blocks of pixels in the facial image data in each frame of each pair;
calculating the difference in position of each block of pixels between the frames of each respective pair; and
averaging the calculated differences in position to estimate the movement between the facial image data in the frames of each respective frame pair.

18. The non-transitory computer-readable recording medium according to claim 15, wherein the step of calculating the confidence score comprises:
inputting the spatial displacement map created for a pair of the selected frames into a machine learning algorithm (MLA); and
calculating a confidence score for the pair of frames using the MLA.

19. The non-transitory computer-readable recording medium according to claim 15, wherein the determining step further comprises:
calculating an overall confidence score from the confidence scores;
comparing the overall confidence score against a threshold confidence score; and
determining the facial image data was taken of a live person when the overall confidence score at least equals the threshold score.

20. The non-transitory computer-readable recording medium according to claim 15, further comprising calculating a liveness detection score for the image data in each frame using at least one of a first machine learning algorithm (MLA) trained model and a second MLA trained model.
